(19) United States
(12) Patent Application Publication
(10) Pub. No.: US 2025/0269643 A1
(43) Pub. Date: Aug. 28, 2025

(54) HEAD CHIP, LIQUID JET HEAD, LIQUID JET RECORDING APPARATUS, AND METHOD OF MANUFACTURING HEAD CHIP

(71) Applicant: Sll Printek Inc., Chiba-shi (JP)

(72) Inventor: Daichi NISHIKAWA, Chiba-shi (JP)

(21) Appl. No.: 19/050,691

(22) Filed: Feb. 11, 2025

(30) Foreign Application Priority Data
Feb. 26, 2024 (JP) 2024-026368

(51) Int. Cl. B41J 2/14

(52) U.S. Cl. CPC B41J 2/14201; B41J 2002/14491

(57) ABSTRACT

A head chip, a liquid jet head, a liquid jet recording apparatus, and a method of manufacturing the head chip which prevent disconnection of a drive electrode and so on and are excellent in long-term reliability are provided. The head chip according to an aspect of the present disclosure includes a chip main body including a pressure chamber configured to retain a liquid and a drive unit disposed in a portion facing the pressure chamber, a drive electrode provided to the drive unit, and a drive wiring line which is provided to the chip main body, and is configured to couple the drive electrode and an external wiring line to each other. The drive wiring line includes a first wiring part including a first region, and a second region which is coupled the first region in an extending direction of the drive wiring line, and is smaller in cross-sectional area perpendicular to the extending direction than the first region, and a second wiring part connected to at least the second region in a direction crossing the extending direction.

### RELATED APPLICATIONS

This application claims priority to Japanese Patent application No. JP2024-026368, filed on Feb. 26, 2024, the entire content of which is incorporated herein by reference.

### BACKGROUND OF THE INVENTION

### 1. Field of the Invention

The present disclosure relates to a head chip, a liquid jet head, a liquid jet recording apparatus, and a method of manufacturing a head chip.

### 2. Description of the Related Art

A head chip to be installed in an inkjet printer is provided with an actuator plate provided with ejection channels and non-ejection channels, and a nozzle plate having nozzle holes communicated with the ejection channels. An individual electrode is formed on an inner side surface of the ejection channel along an extending direction of the ejection channel. A common electrode is formed on an inner side surface of the non-ejection channel along an extending direction of the non-ejection channel.

In the head chip, a voltage is applied between the common electrode and the individual electrode to cause a drive wall to make a thickness-shear deformation to thereby change a volume in the ejection channel. Thus, ink in the ejection channel is ejected through the nozzle hole provided to the nozzle plate.

The individual electrode and the common electrode are coupled to external wiring lines via an individual terminal and a common terminal formed on a surface of the actuator plate (see, e.g., JP2014-151495A (PTL1)).

In PTL1, a dividing groove for dividing the individual terminal and the common terminal from each other is formed in a portion of the surface of the actuator plate, the portion being located between the individual terminal and the common terminal.

However, in the related art described above, the dividing groove reaches the inner side surface of the non-ejection channel. Therefore, the cross-sectional area perpendicular to the extending direction in the common electrode is smaller in a portion where the dividing groove is formed than in a portion where the dividing groove is not formed. In other words, in the common electrode, an electric resistance in the portion where the dividing groove is formed becomes higher compared to an electric resistance in the portion where the dividing groove is not formed. As a result, in the common electrode, the portion where the dividing groove is formed becomes a cause for disconnection and so on when a high current flows.

The present disclosure provides a head chip, a liquid jet head, a liquid jet recording apparatus, and a method of manufacturing the head chip which prevent disconnection of a drive electrode and so on and are excellent in long-term reliability.

### SUMMARY OF THE INVENTION

In order to solve the problems described above, the present disclosure adopts the following aspects.

(1) A head chip according to an aspect of the present disclosure includes a chip main body including a pressure chamber configured to retain a liquid and a drive unit disposed in a portion facing the pressure chamber, a drive electrode provided to the drive unit, and a drive wiring line which is provided to the chip main body, and is configured to couple the drive electrode and an external wiring line to each other, wherein the drive wiring line includes a first wiring part including a first region, and a second region which is coupled the first region in an extending direction of the drive wiring line, and is smaller in cross-sectional area perpendicular to the extending direction than the first region, and a second wiring part connected to at least the second region in a direction crossing the extending direction.

According to the present aspect, regarding the drive wiring line, by forming the second wiring part so as to be connected to at least the second region of the first wiring part, the second region being smaller in cross-sectional area than the first region, it is possible to reduce the maximum resistance value with respect to the whole of the drive wiring line. Thus, even when an unforeseen high current flows through the drive wiring line, it is possible to prevent the disconnection and so on of the drive wiring line. As a result, it is possible to provide the head chip excellent in long-term reliability.

(2) In the head chip according to the aspect (1) described above, it is preferable that the second wiring part is disposed only in a portion of the drive wiring line, the portion including the second region.

According to the present aspect, since the second wiring part is disposed only in a portion including the second region, it is possible to suppress an increase in material cost of the drive wiring line due to the addition of the second wiring part compared to when forming the second wiring part so as to cover the whole of the first wiring part.

(3) In the head chip according to one of the aspects (1) and (2) described above, it is preferable that the second wiring part is disposed so as to cover at least the second region in a first direction perpendicular to a surface on which the drive wiring line is deposited in the chip main body when viewed from the extending direction.

According to the present aspect, since the second wiring part is disposed so as to cover the second region, it is possible to prevent the growth in size of the drive wiring line in a direction along the surface on which the deposition is performed due to the addition of the second wiring part. Thus, it is possible to reduce the maximum resistance value of the whole of the drive wiring line while suppressing an increase in capacitance.

(4) In the head chip according to any one of the aspects (1) through (3) described above, it is preferable that the second wiring part is disposed so as to be integrally connected to at least the second region in a second direction along a surface on which the drive wiring line is deposited in the chip main body when viewed from the extending direction.

According to the present aspect, since the second wiring part is connected to the second region in the direction along the surface on which the deposition is performed, the risk of disconnection and so on can further be reduced. In particular, by ensuring the width dimension of the drive wiring line as in the present aspect, it is possible to reduce the risk such as a deposition failure due to the adhesion of the foreign matter when the cross-sectional area perpendicular to the extending direction is the same compared to when the thickness of the drive wiring line is ensured.

(5) In the head chip according to any one of the aspects (1) through (4) described above, it is preferable that the chip main body is provided with an actuator plate configured by stacking, in the second direction, two piezoelectric substrates different in polarization direction from each other in the second direction, the actuator plate is provided with a jet channel as the pressure chamber configured to retain the liquid, and a non-jet channel which is adjacent to the jet channel, and is configured not to retain the liquid, the drive unit is configured with a portion of the actuator plate, the portion being located between the jet channel and the non-jet channel, the drive electrode includes a common electrode formed at a portion of the drive unit, the portion facing the jet channel, throughout an entire area of the portion in the second direction, and an individual electrode formed at a portion of the drive unit, the portion facing the non-jet channel, throughout an entire area of the portion in the second direction, and the drive wiring line is coupled to the individual electrode in the portion of the drive unit, the portion facing the non-jet channel.

According to the present aspect, in the actuator plate formed of the two piezoelectric substrates different in polarization direction from each other, it is necessary to form the drive electrode (e.g., the individual electrode) throughout the entire area of the drive unit in the second direction. Therefore, by forming the drive wiring line in a portion of the drive unit, the portion facing the non-jet channel, it is possible to enlarge the drive wiring line in the second direction with the second wiring part when forming the individual electrodes. Thus, it is possible to prevent the deterioration of the manufacturing efficiency due to the formation of the second wiring parts since it is unnecessary to separately provide a wiring forming step for forming the second wiring parts.

(6) In the head chip according to any one of the aspects (1) through (5) described above, it is preferable that an obverse surface of the actuator plate is provided with a dividing groove configured to separate a common terminal configured to couple the common electrode and the external wiring line to each other, from an individual terminal configured to couple the individual electrode and the external wiring line to each other, and the second region is located in a portion of the drive unit, the portion facing the non-jet channel and overlapping the dividing groove in the extending direction.

According to the present aspect, since it results in that the second wiring part is formed to the portion overlapping the dividing groove in the extending direction, it is possible to reduce the maximum resistance value with respect to the whole of the drive wiring line while preventing the short circuit between the common terminal and the individual terminal.

(7) A liquid jet head according to an aspect of the present disclosure includes the head chip according to any one of the aspects (1) through (6) described above.

According to the present aspect, it is possible to provide a liquid jet head excellent in reliability.

(8) A liquid jet recording apparatus according to an aspect of the present disclosure includes the liquid jet head according to the aspect (7) described above.

According to the present aspect, it is possible to provide a liquid jet recording apparatus excellent in reliability.

(9) A method of manufacturing a head chip according to an aspect of the present disclosure includes a drive wiring forming step of providing a chip main body including a pressure chamber configured to retain a liquid, and a drive unit which is disposed in a portion facing the pressure chamber, and is provided with a drive electrode, with a drive wiring line configured to couple the drive electrode and an external wiring line to each other, wherein in the drive wiring forming step, the chip main body provided with a first wiring part including a first region, and a second region which is coupled to the first region in an extending direction of the drive wiring line, and is smaller in cross-sectional area perpendicular to the extending direction than the first region is provided with a second wiring part formed so as to be connected to at least the second region in a direction crossing the extending direction.

According to an aspect of the present disclosure, it is possible to provide a head chip, a liquid jet head, a liquid jet recording apparatus, and a method of manufacturing the head chip which prevent disconnection of a drive electrode and so on and are excellent in long-term reliability.

### BRIEF DESCRIPTION OF THE DRAWINGS

FIG. 1 is a schematic diagram of a printer according to a first embodiment.

FIG. 2 is a schematic configuration diagram of an inkjet head and an ink circulation mechanism related to the first embodiment.

FIG. 3 is an exploded perspective view of a head chip according to the first embodiment.

FIG. 4 is a cross-sectional view along the line IV-IV shown in FIG. 3.

FIG. 5 is a cross-sectional view along the line V-V shown in FIG. 3.

FIG. 6 is a cross-sectional view corresponding to the line VI-VI shown in FIG. 5.

FIG. 7 is a cross-sectional view corresponding to the line VII-VII shown in FIG. 5.

FIG. 8 is a cross-sectional view corresponding to the line VIII-VIII shown in FIG. 4.

FIG. 9 is an enlarged view of the IX portion in FIG. 4.

FIG. 10 is a cross-sectional view corresponding to the line X-X shown in FIG. 4.

FIG. 11 is a flowchart illustrating a method of manufacturing the head chip according to the first embodiment.

FIG. 12 is a process diagram illustrating the method of manufacturing the head chip according to the first embodiment.

FIG. 13 is a process diagram illustrating the method of manufacturing the head chip according to the first embodiment.

FIG. 14 is a process diagram illustrating the method of manufacturing the head chip according to the first embodiment.

FIG. 15 is a process diagram illustrating the method of manufacturing the head chip according to the first embodiment.

FIG. 16 is a process diagram illustrating the method of manufacturing the head chip according to the first embodiment.

FIG. 17 is a process diagram illustrating the method of manufacturing the head chip according to the first embodiment.

FIG. 18 is a process diagram illustrating the method of manufacturing the head chip according to the first embodiment.

FIG. 19 is a process diagram illustrating the method of manufacturing the head chip according to the first embodiment.

FIG. 20 is a process diagram illustrating the method of manufacturing the head chip according to the first embodiment.

FIG. 21 is a process diagram illustrating the method of manufacturing the head chip according to the first embodiment.

FIG. 22 is a process diagram illustrating the method of manufacturing the head chip according to the first embodiment.

FIG. 23 is a process diagram illustrating the method of manufacturing the head chip according to the first embodiment.

FIG. 24 is a process diagram illustrating the method of manufacturing the head chip according to the first embodiment.

FIG. 25 is a process diagram illustrating the method of manufacturing the head chip according to the first embodiment.

FIG. 26 is a cross-sectional view corresponding to FIG. 5 with respect to a head chip according to a second embodiment.

FIG. 27 is a cross-sectional view of a portion corresponding to FIG. 7 with respect to the head chip according to the second embodiment.

FIG. 28 is a cross-sectional view corresponding to FIG. 5 with respect to a head chip according to a modified example.

FIG. 29 is a cross-sectional view of a portion corresponding to FIG. 7 with respect to the head chip according to the modified example.

### DETAILED DESCRIPTION OF THE PREFERRED EMBODIMENTS

Some embodiments according to the present disclosure will hereinafter be described with reference to the drawings. In the embodiments and modified examples hereinafter described, constituents corresponding to each other will be denoted by the same reference symbols to omit the descriptions thereof in some cases. In the following descriptions, expressions representing relative or absolute arrangements such as “parallel,” “perpendicular,” “central,” and “coaxial” not only represent strictly such arrangements, but also represent the state of being relatively displaced with a tolerance, or an angle or a distance to the extent that the same function can be obtained. In the following embodiment, the description will be presented citing an inkjet printer (hereinafter referred to simply as a printer) for performing recording on a recording target medium using ink (a liquid) as an example. The scale size of each member is arbitrarily modified so as to provide a recognizable size to the member in the drawings used in the following description.

### First Embodiment

### Printer 1

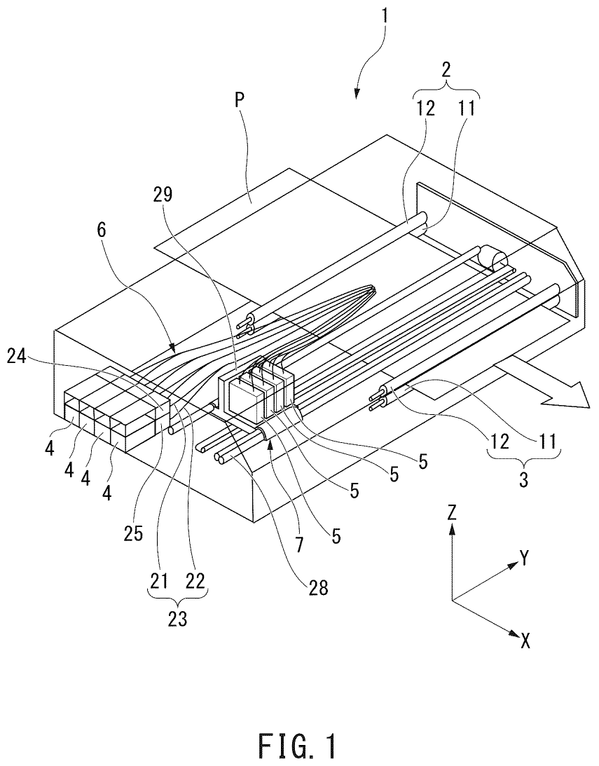

FIG. 1 is a schematic configuration diagram of a printer 1.

As shown in FIG. 1, the printer (a liquid jet recording device) 1 according to the first embodiment is provided with a pair of conveyance mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, the X direction coincides with a conveying direction (a sub-scanning direction) of a recording target medium P (e.g., paper). The Y direction coincides with a scanning direction (a main scanning direction) of the scanning mechanism 7. The Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the first embodiment, the +Z side corresponds to an upper side in the gravitational direction, and the −Z side corresponds to a lower side in the gravitational direction.

The conveyance mechanisms 2, 3 convey the recording target medium P toward the +X side. The conveyance mechanisms 2, 3 each include a pair of rollers 11, 12 extending in, for example, the Y direction.

The ink tanks 4 respectively contain ink of four colors such as yellow, magenta, cyan, and black. The inkjet heads 5 are configured so as to be able to respectively eject the four colors of ink, namely the yellow ink, the magenta ink, the cyan ink, and the black ink according to the ink tanks 4 coupled thereto.

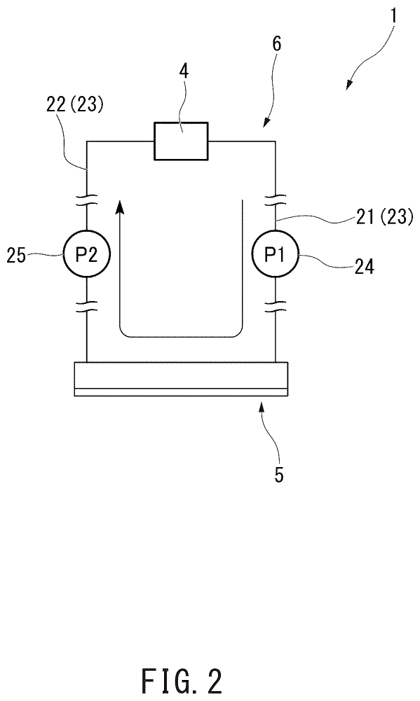

FIG. 2 is a schematic configuration diagram of the inkjet head 5 and the ink circulation mechanism 6.

As shown in FIGS. 1, 2, the ink circulation mechanism 6 circulates the ink between the ink tank 4 and the inkjet head 5. Specifically, the ink circulation mechanism 6 is provided with a circulation flow channel 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 side is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 side is provided with negative pressure with respect to the inkjet head 5. It is arranged that the ink can circulate between the inkjet head 5 and the ink tank 4 through the circulation flow channel 23 by driving the pressure pump 24 and the suction pump 25.

The scanning mechanism 7 makes the inkjet heads 5 perform a reciprocal scan in the Y direction. The scanning mechanism 7 is provided with a guide rail 28 extending in the Y direction, and a carriage 29 movably supported by the guide rail 28.

### Inkjet Heads 5

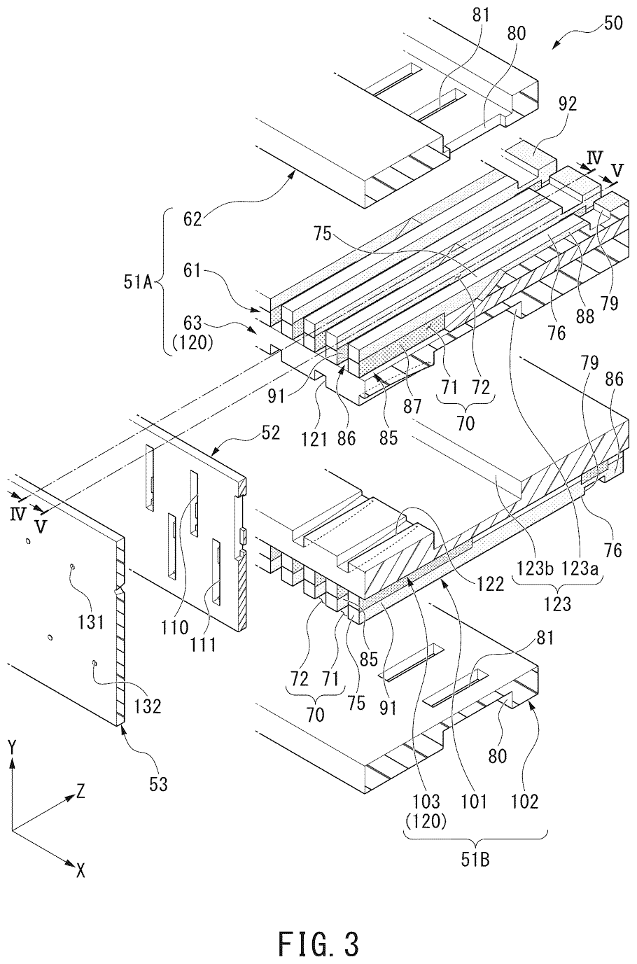

As shown in FIG. 1, the inkjet heads 5 are mounted on the carriage 29. In the illustrated example, the plurality of inkjet heads 5 is mounted on the single carriage 29 so as to be arranged side by side in the Y direction. The inkjet heads 5 are each provided with a head chip 50 (see FIG. 3), an ink supply unit (not shown) for coupling the ink circulation mechanism 6 and the head chip 50, and a control unit (not shown) for applying drive voltages to the head chip 50.

### Head Chip 50

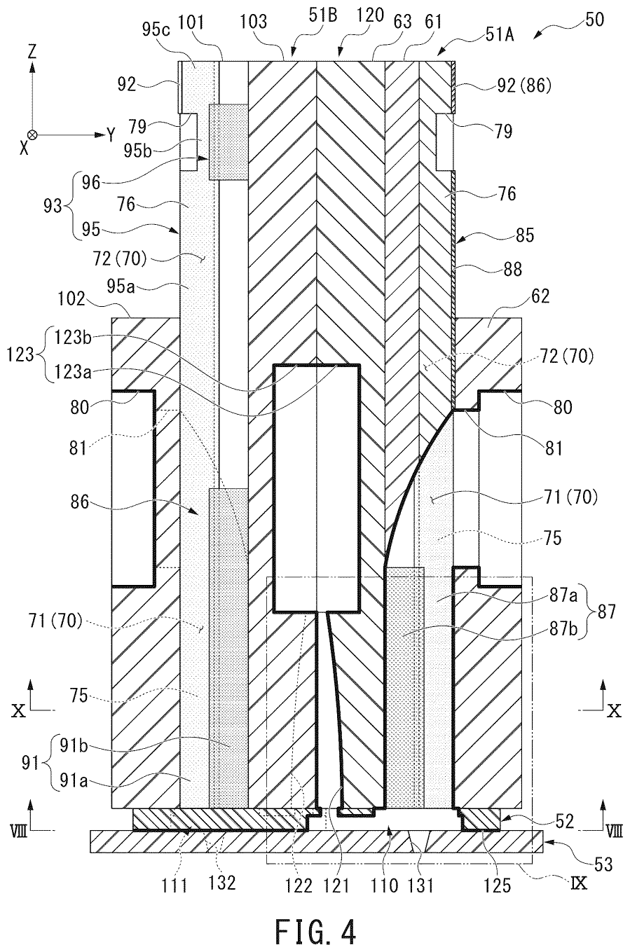

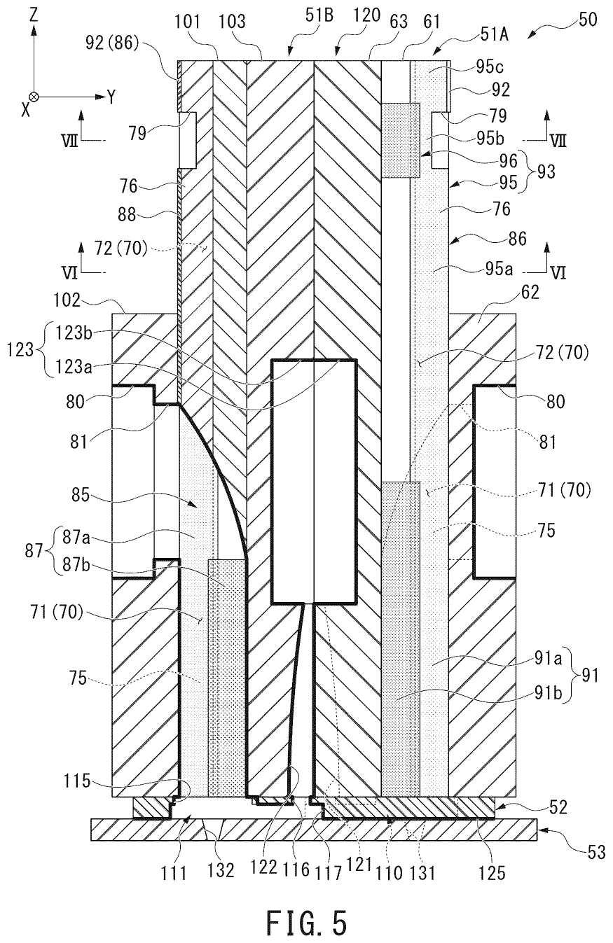

FIG. 3 is an exploded perspective view of the head chip 50. FIG. 4 is a cross-sectional view along the line IV-IV shown in FIG. 3. FIG. 5 is a cross-sectional view along the line V-V shown in FIG. 3.

As shown in FIG. 3 through FIG. 5, the head chip 50 is of a circulation type (a vertical circulation type) which circulates the ink with the ink tank 4 out of so-called edge-shoot types which eject the ink from a tip portion in a channel extension direction (the Z direction) in each of ejection channels 71 described later.

The head chip 50 is provided with a first chip module 51A, a second chip module 51B, a return plate 52, and a nozzle plate 53. In the following explanation, a configuration of each of the chip modules 51A, 51B will be described citing the first chip module 51A as an example. Therefore, the constituents in the second chip module 51B substantially the same as those of the first chip module 51A are denoted by the same reference symbols as in the first chip module 51A, and the description thereof will be omitted in some cases.

### First Chip Module 51A

The first chip module 51A is provided with a first actuator plate 61, a first cover plate 62, and a first back plate 63. In the following explanation, the first chip module 51A will be described defining the +Y side as an obverse surface side, and the −Y side as a reverse surface side.

The first actuator plate 61 is formed of a laminated substrate (a so-called chevron type) having two piezoelectric substrates which are different in polarization direction along the thickness direction (the Y direction (a second direction)) from each other, and are stacked on one another. It should be noted that as the piezoelectric substrates, there is preferably used a ceramics substrate formed of, for example, PZT (lead zirconate titanate). However, the first actuator plate 61 can be formed of a single piezoelectric substrate in which the polarization direction is set in a single direction (a so-called monopole type).

The first actuator plate 61 is provided with the ejection channels (jet channels) 71 each filled with the ink, and non-ejection channels 72 not filled with the ink. The channels 71, 72 are alternately arranged at intervals in the X direction (a first direction) in the first actuator plate 61 to thereby form a channel array 70. The configuration in which the channel extension direction coincides with the Z direction (an extension direction) will be described in the present embodiment, but the channel extension direction can cross the Z direction.

As shown in FIG. 3 and FIG. 4, the ejection channels 71 each have an upper end portion terminating within the first actuator plate 61, and a lower end portion opening on a lower end surface of the first actuator plate 61. Meanwhile, an upper part of each of the ejection channels 71 gradually shallows in depth in the Y direction along the upward direction. A lower part of each of the ejection channels 71 penetrates the first actuator plate 61 in the Y direction.

As shown in FIG. 3 and FIG. 5, the non-ejection channel 72 penetrates the first actuator plate 61 in the Z direction. The non-ejection channel 72 penetrates the first actuator plate 61 in the Y direction over the entire length in the Z direction. In other words, the depth in the Y direction in the non-ejection channel 72 is uniform throughout the entire length in the Z direction.

In the first actuator plate 61, a portion located between each of the ejection channels 71 and corresponding one of the non-ejection channels 72 constitutes a drive wall 75. Therefore, both sides in the X direction of the ejection channel 71 are surrounded by the pair of drive walls 75. In the first actuator plate 61, a portion located above the ejection channel 71 constitutes a tail part 76.

### First Cover Plate 62

As shown in FIG. 3 through FIG. 5, the first cover plate 62 is bonded to the obverse surface of the first actuator plate 61. Specifically, the first cover plate 62 closes the obverse surface-side openings of the channels 71, 72 in a state of exposing the obverse surfaces of the tail parts 76. A lower end surface of the first cover plate 62 is arranged so as to be coplanar with the lower end surface of the first actuator plate 61.

In the first cover plate 62, at positions overlapping the upper parts of the ejection channels 71 when viewed from the Y direction, there is formed a common ink chamber 80. The common ink chamber 80 extends in the X direction with a length sufficient for straddling, for example, the channel array 70, and at the same time, opens on the obverse surface of the first cover plate 62. The common ink chamber 80 is indirectly connected to the ink supply tube 21 through an entrance port not shown.

In the common ink chamber 80, at the positions overlapping the upper parts of the respective ejection channels 71 when viewed from the Y direction, there are individually formed slits 81. The slits 81 each communicate the inside of the ejection channel 71 and the inside of the common ink chamber 80 with each other through the upper part of the ejection channel 71. Therefore, the common ink chamber 80 is communicated with the ejection channels 71 through the respective slits 81 on the one hand, but is not communicated with the non-ejection channels 72 on the other hand.

### First Back Plate 63

The first back plate 63 is bonded to a reverse surface of the first actuator plate 61. The first back plate 63 has an equivalent outer shape to that of the first actuator plate 61 when viewed from the Y direction. The first back plate 63 is overlapped with the whole of the first actuator plate 61 when viewed from the Y direction. In other words, the first back plate 63 closes reverse surface side openings of the channels 71, 72.

As shown in FIG. 3, the first actuator plate 61 is provided with common wiring lines 85 and individual wiring lines 86 as drive wiring lines.

As shown in FIG. 3 and FIG. 4, the common wiring lines 85 are each provided with a common electrode 87 and a common terminal 88.

The common electrode 87 is formed on inner side surfaces opposed to each other in the X direction out of the inner surfaces of the ejection channel 71. In the illustrated example, the common electrode 87 is formed throughout the entire area in the Y direction and the Z direction on the inner side surfaces of the ejection channel 71. It should be noted that it is sufficient for the common electrode 87 to be provided to at least a portion of the inner side surface of the ejection channel 71, the portion being located below the lower-end opening edge of the slit 81.

As shown in FIG. 4, the common electrode 87 according to the first embodiment is formed throughout the entire area in the Y direction in the inner side surface of the ejection channel 71 with an obverse surface-side common part 87a and a reverse surface-side common part 87b. Specifically, the obverse surface-side common part 87a forms an obverse surface-side region of the common electrode 87. Specifically, a +Y-side end edge of the obverse surface-side common part 87a coincides with an obverse surface-side opening edge of the ejection channel 71. A −Y-side end edge of the obverse surface-side common part 87a is located at the −Y side with respect to the center in the Y direction of the inner side surface of the ejection channel 71.

The reverse surface-side common part 87b forms a reverse surface-side region of the common electrode 87. Specifically, a −Y-side end edge of the reverse surface-side common part 87b coincides with a reverse surface-side opening edge of the ejection channel 71. A +Y-side end edge of the reverse surface-side common part 87b is located at the +Y side with respect to the center in the Y direction of the inner side surface of the ejection channel 71. In other words, a part of the reverse surface-side common part 87b overlaps the obverse surface-side common part 87a in a portion of the inner side surface of the ejection channel 71, the portion including the center in the Y direction.

As shown in FIG. 3, the common terminal 88 is formed on an obverse surface of the tail part 76. The common terminal 88 is disposed on the obverse surface of the tail part 76 so as to correspond to each of the ejection channels 71. Each of the common terminals 88 extends linearly in the Z direction above corresponding one of the ejection channels 71. The lower end portion in the common terminal 88 is connected to the common electrode 87 in an upper-end opening edge of the ejection channel 71.

As shown in FIG. 3 and FIG. 5, the individual wiring line 86 is provided with individual electrodes 91, an individual terminal 92, a routing wiring line 93, and a bypass wiring line 94.

The individual electrodes 91 are each formed on a lower portion of one of the inner side surfaces opposed to each other in the X direction out of the inner surfaces of each of the non-ejection channels 72. Specifically, a lower end edge of the individual electrode 91 coincides with the lower end opening edge of the non-ejection channel 72. An upper end edge of the individual electrode 91 is located within a height range of the common ink chamber 80. In other words, at least a part of the individual electrode 91 faces the common electrode 87 across the drive wall 75 in the X direction. In the illustrated example, the individual electrode 91 is formed throughout the entire area in the Y direction in the non-ejection channel 72 throughout the entire length in the Z direction. It should be noted that it is sufficient for the individual electrode 91 to be provided to at least a portion located below the lower-end opening edge of the slit 81.

As shown in FIG. 5, the individual electrode 91 according to the first embodiment is formed throughout the entire area in the Y direction in the inner side surface of the non-ejection channel 72 with an obverse surface-side individual part 91a and a reverse surface-side individual part 91b. Specifically, the obverse surface-side individual part 91a forms an obverse surface-side region of the individual electrode 91. Specifically, a +Y-side end edge of the obverse surface-side individual part 91a coincides with an obverse surface-side opening edge of the non-ejection channel 72. A −Y-side end edge of the obverse surface-side individual part 91a is located at the −Y side with respect to the center in the Y direction of the inner side surface of the non-ejection channel 72.

The reverse surface-side individual part 91b forms a reverse surface-side region of the individual electrode 91. Specifically, a −Y-side end edge of the reverse surface-side individual part 91b coincides with a reverse surface-side opening edge of the non-ejection channel 72. A +Y-side end edge of the reverse surface-side individual part 91b is located at the +Y side with respect to the center in the Y direction of the inner side surface of the non-ejection channel 72. In other words, a part of the reverse surface-side individual part 91b overlaps the obverse surface-side individual part 91a in a portion of the inner side surface of the non-ejection channel 72, the portion including the center in the Y direction.

The individual terminal 92 is provided to a portion located above the common terminal 88 on the obverse surface of the tail part 76. The individual terminal 92 is formed to have a strip shape extending in the X direction. The individual terminal 92 reaches obverse surface-side opening edges of the non-ejection channels 72 facing each other in the X direction across the ejection channel 71. In the tail part 76, in a portion located between the common terminal 88 and the individual terminal 92, there is formed a dividing groove 79. The dividing groove 79 opens on the obverse surface of the tail part 76, and at the same time, extends in the X direction. The dividing groove 79 separates the common terminal 88 and the individual terminal 92 from each other. The dividing groove 79 is formed to have a depth in the Y direction smaller than a half of the thickness of the first actuator plate 61. However, the depth of the dividing groove 79 can be changed as appropriate.

The routing wiring line 93 is a wiring line which couples the individual electrode 91 and the individual terminal 92 to each other. The routing wiring line 93 is provided with a first wiring part 95 and a second wiring part 96.

The first wiring part 95 is a wiring line which functions as a base of the routing wiring line 93. The first wiring part 95 extends upward from the individual electrode 91 on the inner side surface of the non-ejection channel 72. The first wiring part 95 extends throughout the entire length in the Z direction in a portion of the inner side surface of the non-ejection channel 72, the portion being located above the common electrode 87. Specifically, the first wiring part 95 is provided with a first region 95a, a second region 95b, and a third region 95c.

The first region 95a is a portion of the inner side surface of the non-ejection channel 72, the portion being located between the individual electrode 91 and the dividing groove 79. The first region 95a extends in the Z direction with a uniform width in the Y direction. The first region 95a formed to have a width in the Y direction smaller than the thickness of the first actuator plate 61. In the illustrated example, the first region 95a is formed to be equivalent in width to the obverse surface-side individual part 91a. Specifically, an obverse surface-side end edge in the first region 95a reaches the obverse surface-side opening edge of the non-ejection channel 72. A reverse surface-side end edge in the first region 95a is located at the −Y side from the center in the Y direction in the non-ejection channel 72.

The second region 95b extends upward from the first region 95a. The second region 95b is a portion of the inner side surface of the non-ejection channel 72, the portion being located within a height range of the dividing groove 79. In other words, the second region 95b extends in the Z direction throughout the entire length of the dividing groove 79 in a portion of the inner side surface of the non-ejection channel 72, the portion being located at the −Y side with respect to the dividing groove 79.

The second region 95b is formed to have a width in the Y direction uniform throughout the entire length in the Z direction. Specifically, an obverse surface-side end edge in the second region 95b reaches the reverse surface-side end edge of the dividing groove 79. The reverse surface-side end edge in the second region 95b is disposed at a position equivalent in the Y direction to the reverse surface-side end edge in the first region 95a. In other words, the width of the second region 95b in the Y direction is reduced with respect to the first region 95a by the depth of the dividing groove 79.

The third region 95c extends upward from the second region 95b. The third region 95c extends in the Z direction in a portion of the inner side surface of the non-ejection channel 72, the portion being located above the dividing groove 79. An upper end edge of the third region 95c reaches the upper end opening edge of the non-ejection channel 72. The width of the third region 95c in the Y direction is made equivalent to that of the first region 95a. Specifically, an obverse surface-side end edge in the third region 95c reaches the obverse surface-side opening edge of the non-ejection channel 72. A reverse surface-side end edge in the third region 95c is located at the −Y side from the center in the Y direction in the non-ejection channel 72. The individual terminal 92 couples the third regions 95c of the routing wiring lines 93 facing each other in the X direction across the ejection channel 71 to each other in the obverse surface-side opening edge of the non-ejection channel 72.

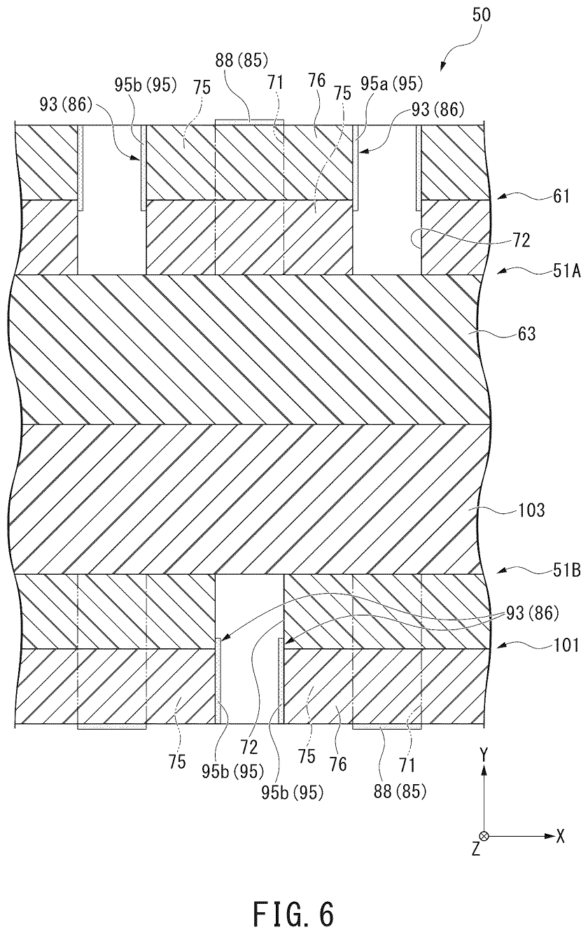

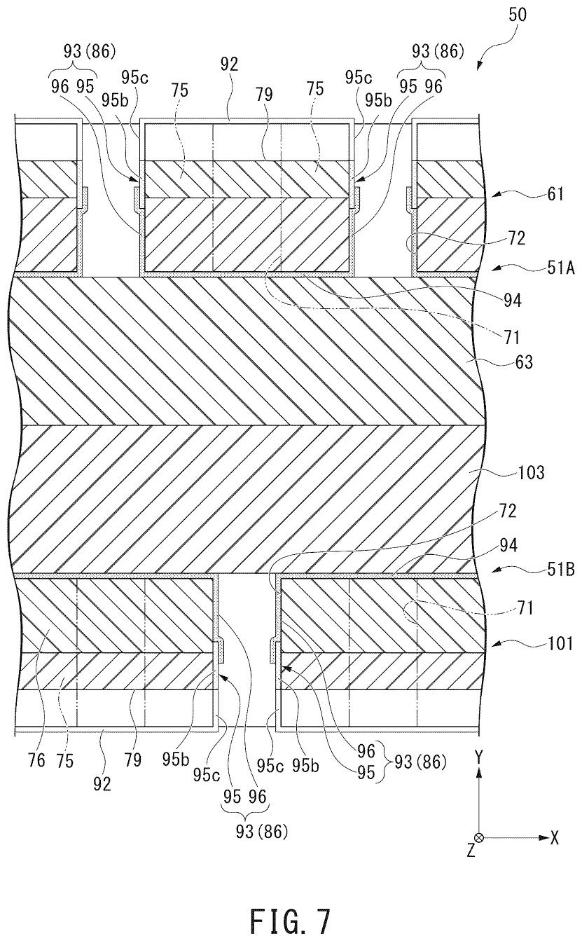

FIG. 6 is a cross-sectional view corresponding to the line VI-VI shown in FIG. 5. FIG. 7 is a cross-sectional view corresponding to the line VII-VII shown in FIG. 5.

As shown in FIG. 6 and FIG. 7, the routing wiring line 93 is formed to have a thickness (a dimension in a direction perpendicular to the inner side surface of the non-ejection channel 72) in the X direction uniform throughout the entire length. Therefore, the cross-sectional area of the cross-sectional surface perpendicular to the Z direction in the routing wiring line 93 is the smallest in the second region 95b. In other words, the electric resistance of the routing wiring line 93 is higher in the second region 95b compared to the electric resistance thereof in the first region 95a and the third region 95c.

As shown in FIG. 5 and FIG. 7, the second wiring part 96 is a wiring line formed in addition to the first wiring part 95. The second wiring part 96 is formed so as to be connected to at least the second region 95b on the inner side surface of the non-ejection channel 72. In the Z direction, the second wiring part 96 is formed so as to include the whole of the second region 95b and to straddle a boundary portion of the first region 95a with the second region 95b, and a boundary portion of the third region 95c with the second region 95b. In other words, the second wiring part 96 is disposed only in a portion of the routing wiring line 93, the portion including the second region 95b.

In the Y direction, the second wiring part 96 overlap a part of the first wiring part 95 (the second region 95b), and protrudes toward the −Y side from the second region 95b. Specifically, the obverse surface-side end portion in the second wiring part 96 overlaps the reverse surface-side end portion of the second region 95b when viewed from the X direction. A reverse surface-side end edge in the second wiring part 96 reaches the reverse surface-side opening edge of the non-ejection channel 72. In other words, the portion of the routing wiring line 93, the portion being located within a height range of the dividing groove 79, is formed on the entire area in the Y direction with respect to the inner side surface of the non-ejection channel 72 with the second region 95b and the second wiring part 96. It should be noted that an amount of the overlap between the reverse surface-side end portion of the second region 95b and the obverse surface-side end portion of the second wiring part 96 is preferably, for example, no smaller than 10 um taking a variation in evaporation depth and so on into consideration. Thus, the reliability in conduction between the reverse surface-side end portion of the second region 95b and the obverse surface-side end portion of the second wiring part 96 can be ensured.

As described above, the routing wiring line 93 related to the first embodiment is configured by the second wiring part 96 overlapping a part of the first wiring part 95. In this case, the cross-sectional area in a direction perpendicular to the Z direction in the routing wiring line 93 is set to be larger than the cross-sectional area of the second region 95b alone in any places in the Z direction. In other words, the electric resistance of the routing wiring line 93 is made lower than the electric resistance of the second region 95b alone in any places in the Z direction.

The bypass wiring line 94 is formed in a portion facing the dividing groove 79 in the Y direction on the reverse surface of the actuator plate 61. The bypass wiring line 94 is formed to have a strip shape extending in the X direction. The bypass wiring line 94 reaches reverse surface-side opening edges of the non-ejection channels 72 facing each other in the X direction across the ejection channel 71. The bypass wiring line 94 couples the second wiring parts 96 facing each other in the X direction across the ejection channel 71.

To the obverse surface of the tail part 76, there is pressure-bonded a flexible printed board (not shown) as external wiring lines. The flexible printed board is coupled to the common terminals 88 and the individual terminals 92 on the obverse surfaces of the tail parts 76. The flexible printed board couples the first chip module 51A and the control unit to each other.

### Second Chip Module 51B

The second chip module 51B is provided with a second actuator plate 101, a second cover plate 102, and a second back plate 103. The second chip module 51B has the second back plate 103, the second actuator plate 101, and the second cover plate 102 overlapped in sequence from the +Y side toward the −Y side. The second chip module 51B is overlapped with the first chip module 51A in a state in which the obverse surface side (the −Y side) faces to an opposite side to the first chip module 51A. Specifically, the first chip module 51A and the second chip module 51B are integrated with each other by the reverse surfaces of the first back plate 63 and the second back plate 103 being bonded to each other. In this case, the lower end surfaces of the respective chip modules 51A, 51B are arranged so as to be coplanar with each other.

The ejection channels 71 and the non-ejection channels 72 of the second chip module 51B are arranged so as to be shifted as much as a half pitch with respect to the arrangement pitch of the ejection channels 71 and the non-ejection channels 72 of the first chip module 51A. In other words, the ejection channels 71 of the chip modules 51A, 51B, and the non-ejection channels 72 of the chip modules 51A, 51B are each arranged in a zigzag manner. In this case, the ejection channels 71 of the first chip module 51A and the non-ejection channels 72 of the second chip module 51B face each other in the Y direction, and the non-ejection channels 72 of the first chip module 51A and the ejection channels 71 of the second chip module 51B face each other in the Y direction. It should be noted that the pitch of the channels 71, 72 in each of the chip modules 51A, 51B can be changed as appropriate.

### Return Plate 52

The return plate 52 is bonded to the lower end surfaces of the respective chip modules 51A, 51B in a lump via an adhesive. The return plate 52 closes the lower end opening parts of the respective channels 71, 72. The return plate 52 is formed of, for example, polyimide. The return plate 52 is provided with a plurality of first communication channels 110 and a plurality of second communication channels 111.

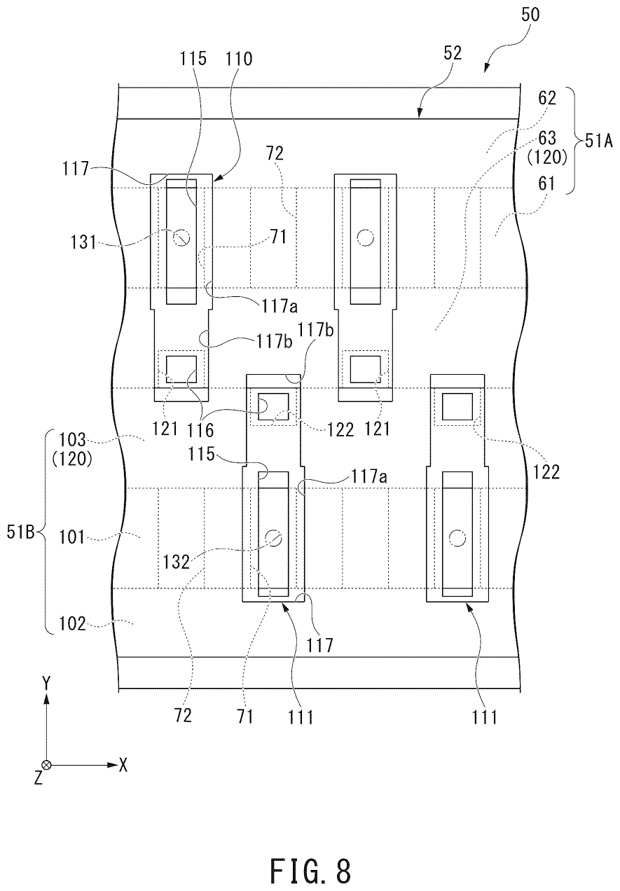

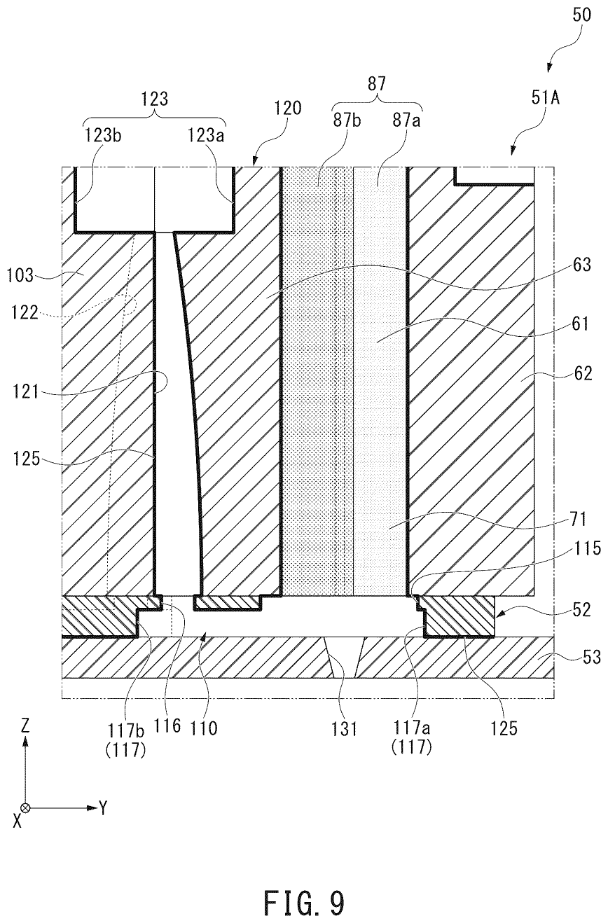

FIG. 8 is a cross-sectional view corresponding to the line VIII-VIII shown in FIG. 4. FIG. 9 is an enlarged view of a part IX in FIG. 4.

As shown in FIG. 8 and FIG. 9, the plurality of first communication channels 110 is formed individually at equivalent positions in the X direction to those of the respective ejection channels 71 in the first chip module 51A. In the present embodiment, the plurality of first communication channels 110 is formed at intervals in the X direction so as to correspond to the arrangement pitch of the ejection channels 71. Each of the first communication channels 110 is formed to have a U-shape in a side view viewed from the X direction. Specifically, each of the first communication channels 110 is provided with an upstream opening 115, a downstream opening 116, and a connecting part 117. Since the first communication channels 110 have substantially the same configurations, in the following configuration, the details of the first communication channels 110 will be described citing one of the first communication channels 110 as an example.

The upstream opening 115 is formed at a position overlapping the ejection channel 71 in a plan view. The upstream opening 115 has an upper end portion opening on an upper surface of the return plate 52, and a lower end portion terminating in the return plate 52. The upstream opening 115 is communicated with the inside of the ejection channel 71 through the lower-end opening of the ejection channel 71. In the first embodiment, the flow channel cross-sectional area (the cross-sectional area perpendicular to the Z direction) of the upstream opening 115 is uniform throughout the entire length in the Z direction. However, the flow channel cross-sectional area of the upstream opening 115 can change in accordance with a position in the Z direction.

At least a part of an opening edge of the upstream opening 115 is arranged at an outer side of a lower-end opening edge of the ejection channel 71 in the plan view. Specifically, a dimension in the X direction in the upstream opening 115 is smaller than a dimension in the X direction in the lower end opening of the ejection channel 71. A dimension in the Y direction in the upstream opening 115 is larger than a dimension in the Y direction in the lower end opening of the ejection channel 71. In the lower end surface of the first chip module 51A, portions located at both sides in the Y direction with respect to the ejection channel 71 are exposed through the upstream opening 115.

The downstream opening 116 is formed at a position overlapping the first back plate 63 in a plan view. The downstream opening 116 has an upper end portion opening on the upper surface of the return plate 52, and a lower end portion terminating in the return plate 52. A dimension in the Z direction in the downstream opening 116 is made equivalent to that of the upstream opening 115. In the present embodiment, the flow channel cross-sectional area (the cross-sectional area perpendicular to the Z direction) of the downstream opening 116 is uniform throughout the entire length in the Z direction. It should be noted that the flow channel cross-sectional area of the downstream opening 116 can change in accordance with a position in the Z direction.

The connecting part 117 communicates the upstream opening 115 and the downstream opening 116 with each other. The connecting part 117 opens only on the lower surface of the return plate 52, and at the same time, extends in the Y direction. A dimension in the Z direction in the connecting part 117 is made uniform throughout the entire length in the Y direction. In the present embodiment, the dimension in the Z direction in the connecting part 117 is larger than the dimensions in the Z direction in the upstream opening 115 and the downstream opening 116. However, the dimension in the Z direction in the connecting part 117 may be made different in accordance with a position in the Y direction.

The connecting part 117 is larger in dimension in the X direction than the upstream opening 115 and the downstream opening 116 in the plan view. Specifically, the connecting part 117 is provided with an upstream wide part 117a and a downstream wide part 117b.

The upstream wide part 117a is arranged at a position overlapping the upstream opening 115 in the plan view. The upstream wide part 117a is made one size larger than the upstream opening 115 in the plan view. The upstream opening 115 opens on a surface (a bottom surface) facing downward out of the inner surfaces of the upstream wide part 117a.

The downstream wide part 117b extends toward the −Y side from the upstream wide part 117a. The downstream wide part 117b overlaps the downstream opening 116 in the plan view. The downstream wide part 117b is made one size larger than the downstream opening 116 in the plan view. A dimension in the X direction in the downstream wide part 117b is made smaller than that of the upstream wide part 117a. The downstream opening 116 opens on the bottom surface of the downstream wide part 117b.

As shown in FIG. 5, the plurality of second communication channels 111 is formed individually at equivalent positions in the X direction to those of the respective ejection channels 71 in the second chip module 51B. In the present embodiment, the plurality of second communication channels 111 is formed at intervals in the X direction so as to correspond to the arrangement pitch of the ejection channels 71 of the second chip module 51B. Specifically, the first communication channels 110 and the second communication channels 111 are alternately arranged at intervals in the X direction. It should be noted that the second communication channels 111 have substantially the same configuration as that of the first communication channels 110. Therefore, substantially the same constituents of the second communication channels 111 as those of the first communication channels 110 are denoted by the same reference symbols to omit the detailed description of the second communication channels 111.

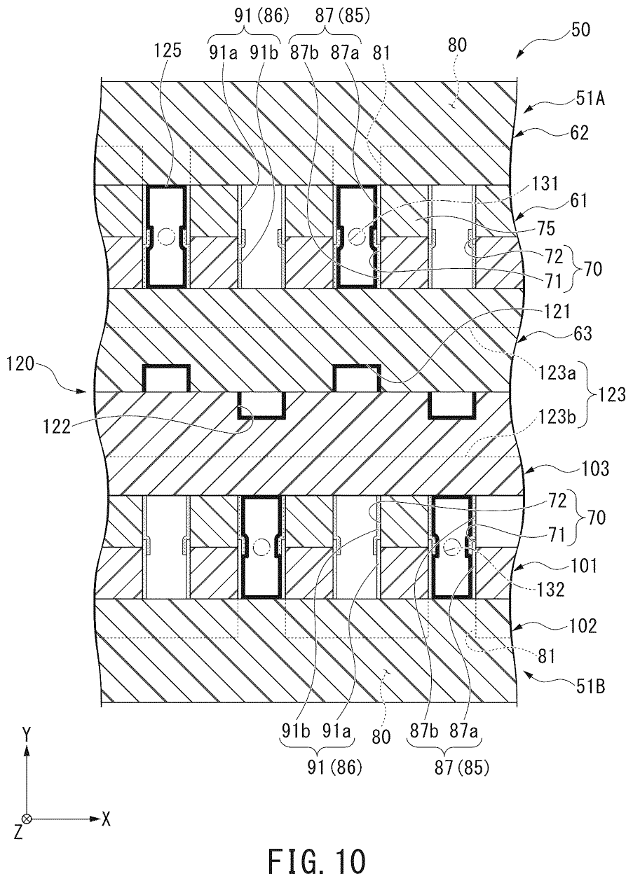

FIG. 10 is a cross-sectional view corresponding to the line X-X shown in FIG. 4.

As shown in FIG. 4 and FIG. 10, the first back plate 63 and the second back plate 103 constitute a flow channel plate 120 in a state in which the first back plate 63 and the second back plate 103 overlap each other. The flow channel plate 120 is provided with a plurality of first connecting channels 121, a plurality of second connecting channels 122, and a manifold 123.

The plurality of first connecting channels 121 is formed individually at positions overlapping the downstream openings 116 of the respective first communication channels 110 in the plan view. The first connecting channels 121 are arranged at intervals in the X direction at the same pitch as that of the first communication channels 110. Specifically, the first connecting channels 121 open on the reverse surface of the first back plate 63. The reverse surface side openings in the first connecting channels 121 are closed by the second back plate 103.

The first connecting channels 121 each extend linearly in the Z direction when viewed from the Y direction. A lower end portion in each of the first connecting channels 121 opens on the lower end surface of the first back plate 63. Thus, the lower end opening of each of the first connecting channels 121 is communicated with the downstream opening 116. In contrast, an upper end portion in each of the first connecting channels 121 terminates in the first back plate 63.

As shown in FIG. 8, the lower end opening of each of the first connecting channels 121 is made larger in dimension in the X direction than the downstream opening 116, and is made smaller in dimension in the X direction than the downstream wide part 117b. In this case, an opening edge of the downstream opening 116 flares to the inside of the lower-end opening edge of the first connecting channel 121. However, it is possible for the lower end opening in each of the first connecting channels 121 to be made larger in dimension in the X direction than the downstream wide part 117b, or made smaller in dimension in the X direction than the downstream opening 116.

As shown in FIG. 10, the plurality of second connecting channels 122 is formed individually at positions overlapping the downstream openings 116 of the respective second communication channels 111 in the plan view. The second connecting channels 122 are arranged at intervals in the X direction at the same pitch as that of the second communication channels 111. Specifically, the first connecting channels 121 and the second connecting channels 122 are alternately arranged in the X direction.

As shown in FIG. 5 and FIG. 8, each of the second connecting channels 122 is communicated with the downstream opening 116 of corresponding one of the second communication channels 111. Specifically, the second connecting channels 122 open on the reverse surface (a surface facing to the +Y side) of the second back plate 103. The reverse surface side openings in the second connecting channels 122 are closed by the first back plate 63. The second connecting channels 122 extend in the Z direction. A lower end portion in each of the second connecting channels 122 opens on the lower end surface of the second back plate 103. Thus, the lower end opening of each of the second connecting channels 122 is communicated with the downstream opening 116 of corresponding one of the second communication channels 111. In contrast, an upper end portion in each of the second connecting channels 122 terminates in the second back plate 103. It should be noted that it is possible to set the dimensions and so on of the second connecting channels 122 to substantially the same as those of the first connecting channels 121.

The manifold 123 is provided to a portion located above the connecting channels 121, 122 in the flow channel plate 120. The manifold 123 is formed by overlapping a first recess 123a provided to the first back plate 63 and a second recess 123b provided to the second back plate 103 each other. The first recess 123a is a recess which opens on the reverse surface of the first back plate 63, and which extends in the Z direction and the Y direction. The second recess 123b is a recess which opens on the reverse surface of the second back plate 103, and which extends in the Z direction and the Y direction. The manifold 123 is formed by communicating the reverse surface side openings of the first recess 123a and the second recess 123b with each other. It should be noted that the manifold 123 may be provided with a configuration in which a recess provided to either one of the first back plate 63 and the second back plate 103 is closed by the reverse surface of the other of the back plates.

The connecting channels 121, 122 are communicated in a lump with the manifold 123. Specifically, the upper end opening of each of the first connecting channels 121 opens on the lower end surface of the first recess 123a. An upper end opening of each of the second connecting channels 122 opens on the lower end surface of the second recess 123b. It should be noted that the manifold 123 is indirectly connected to the ink discharge tube 22 through an exit port not shown.

The chip modules 51A, 51B and the return plate 52 are covered with protective films 125. In the present embodiment, the protective films 125 are also formed on an inner surface of the common ink chamber 80, inner surfaces of the slits 81, inner surfaces of the ejection channels 71, inner surfaces of the communication channels 110, 111, inner surfaces of the connecting channels 121, 122, and an inner surface of the manifold 123. The protective films 125 each include an organic insulating material such as a para-xylylene resin material (e.g., parylene (a registered trademark)) as a material having an insulating property. The protective films 125 can be formed of tantalum oxide (Ta₂O₅), silicon nitride (SiN), silicon carbide (SiC), silicon oxide (SiO₂), diamond-like carbon, or the like, or can include at least any one of these materials.

### Nozzle Plate 53

As shown in FIG. 3 through FIG. 5, the nozzle plate 53 is bonded to the lower end surface of the return plate 52. A plurality of nozzle holes (first nozzle holes 131 and second nozzle holes 132) each penetrating the nozzle plate 53 in the Z direction is arranged in the nozzle plate 53.

In the nozzle plate 53, the plurality of first nozzle holes 131 is formed individually at positions overlapping the respective first communication channels 110 in the plan view. In other words, the first nozzle holes 131 are arranged at intervals in the X direction at the same pitch as that of the first communication channels 110. The first nozzle holes 131 are communicated with the corresponding ejection channels 71 of the first chip module 51A through the corresponding first communication channels 110, respectively. Specifically, the first nozzle holes 131 are each formed at a position overlapping the ejection channel 71 and the upstream wide part 117a in the plan view in a +Y-side end portion in corresponding one of the first communication channels 110. It should be noted that the first nozzle holes 131 can be communicated with the first communication channels 110 at positions shifted in the Y direction from the ejection channels 71 of the first chip module 51A, respectively.

In the nozzle plate 53, the plurality of second nozzle holes 132 is formed individually at positions overlapping the respective second communication channels 111 in the plan view. In other words, the second nozzle holes 132 are arranged at intervals in the X direction at the same pitch as that of the second communication channels 111. The second nozzle holes 132 are communicated with the corresponding ejection channels 71 of the second chip module 51B through the corresponding second communication channels 111, respectively. Specifically, the second nozzle holes 132 are each formed at a position overlapping the ejection channel 71 and the upstream wide part 117a in the plan view in a −Y-side end portion in corresponding one of the second communication channels 111. It should be noted that the second nozzle holes 132 may be communicated with the second communication channels 111 at positions shifted in the Y direction from the ejection channels 71 of the second chip module 51B, respectively.

### Operation Method of Printer 1

Then, there will hereinafter be described when recording a character, a figure, or the like on the recording target medium P using the printer 1 configured as described above.

It should be noted that it is assumed that as an initial state, the sufficient ink having colors different from each other is respectively encapsulated in the four ink tanks 4 shown in FIG. 1. Further, there is provided a state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12. By the carriage 29 moving in the Y direction at the same time as the conveyance of the recording target medium P, the inkjet heads 5 mounted on the carriage 29 make a reciprocal motion in the Y direction.

Here, the operation of each of the inkjet heads 5 will hereinafter be described in detail.

In such a vertically circulating type head chip 50 as in the present embodiment, first, by making the pressure pump 24 and the suction pump 25 shown in FIG. 2 operate, the ink is circulated in the circulation flow channel 23. In this case, the ink circulating through the ink supply tube 21 flows into the common ink chamber 80 of each of chip modules 51 through the entrance port. The ink having flowed into the common ink chambers 80 is supplied to the inside of each of the ejection channels through the slit 81. The ink having flowed into the ejection channels 71 gathers in the manifold 123 through the communication channels 110, 111 and the connecting channels 121, 122, and is then discharged to the ink discharge tube 22 through the exit port. The ink discharged to the ink discharge tube 22 is returned to the ink tank 4, and is then supplied again to the ink supply tube 21. Thus, the ink is circulated between the inkjet head 5 and the ink tank 4.

Then, when the reciprocation is started by the carriage 29, the drive voltages are applied to the electrodes 87, 91 via the flexible boards. On this occasion, the drive voltage is applied between the electrodes 87, 91 by setting the individual electrode 91 at a drive potential Vdd, and the common electrode 87 at a reference potential GND. Then, a thickness shear deformation occurs in the two drive walls 75 partitioning the ejection channel 71, and the two drive walls 75 each deform so as to protrude toward the non-ejection channel 72. Specifically, the actuator plates 61, 101 in the present embodiment each have two piezoelectric substrates on which the polarization treatment has been performed in the thickness direction (the Y direction), and which are stacked on one another, and therefore, by applying the drive voltage, the actuator plates 61, 101 each make a flexural deformation having a V-shape centering on an intermediate position in the Y direction in the drive walls 75. Thus, the ejection channel 71 deforms as if it bulges.

When the volume of the ejection channel 71 increases due to the deformation of the two drive walls 75, the ink in the common ink chamber 80 is induced into the ejection channel 71 through the slit 81. Then, the ink induced to the inside of the ejection channel 71 propagates to the inside of the ejection channel 71 as a pressure wave, and the drive voltage applied between the electrodes 87, 91 is set to zero at the timing at which the pressure wave reaches the nozzle hole 131, 132.

Thus, the drive walls 75 are restored, and the volume of the ejection channel 71 having once increased is restored to the original volume. Due to this operation, the internal pressure of the ejection channel 71 increases to pressurize the ink. As a result, it is possible to eject the ink from the nozzle hole 131, 132. On this occasion, the ink turns to an ink droplet having a droplet shape when passing through the nozzle hole 131, 132, and is then ejected. Thus, it is possible to record a character, an image, or the like on the recording target medium P as described above. In other words, in the head chip 50 according to the present embodiment, out of the ink flowing through each of the communication channels 110, 111, a part is ejected through corresponding one of the nozzle holes 131, 132, while the rest is returned to the manifold 123 through corresponding one of the connecting channels 121, 122.

### Method of Manufacturing Head Chip 50

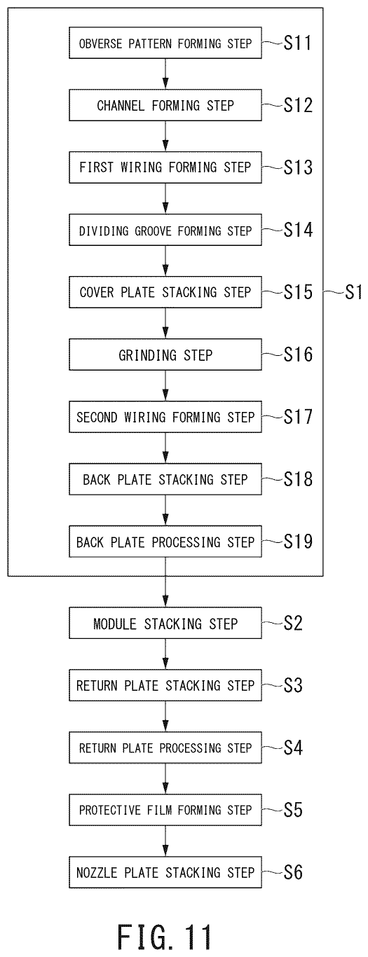

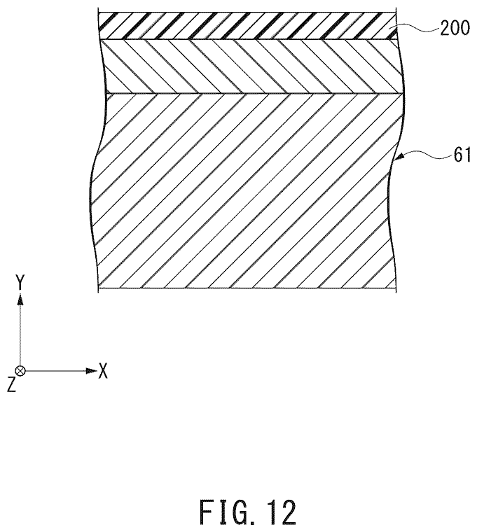

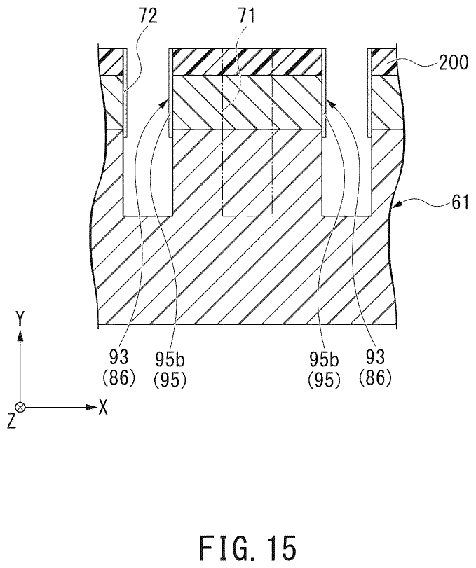

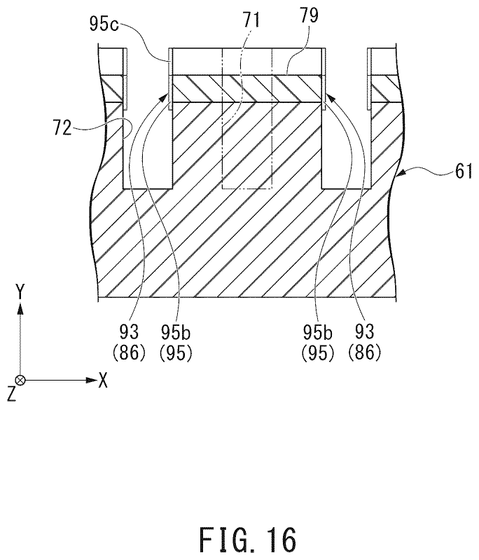

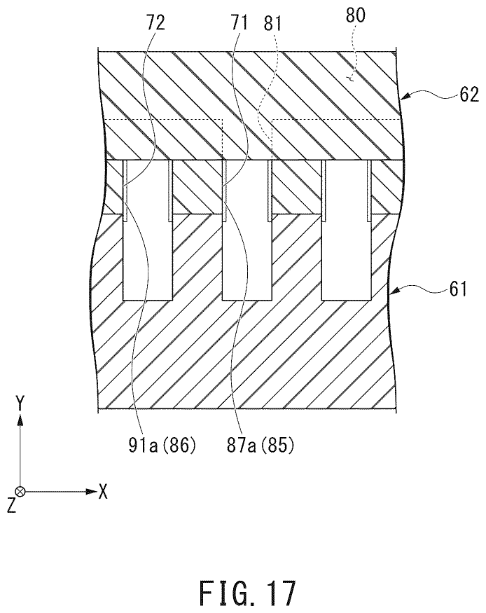

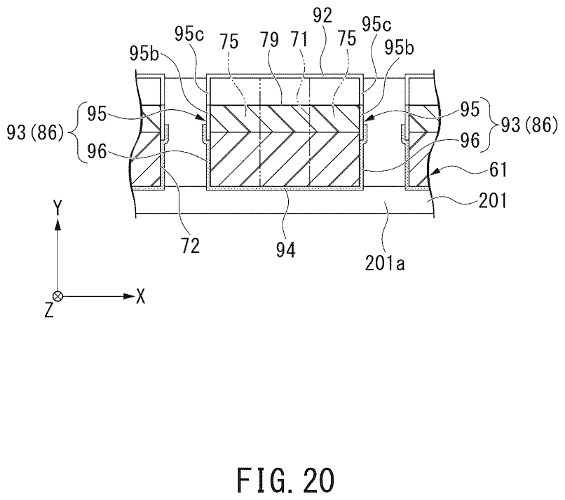

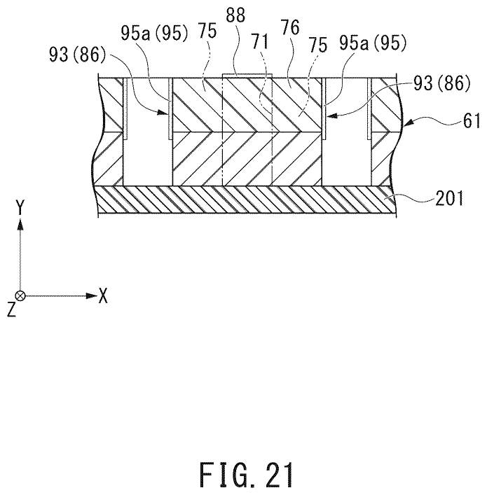

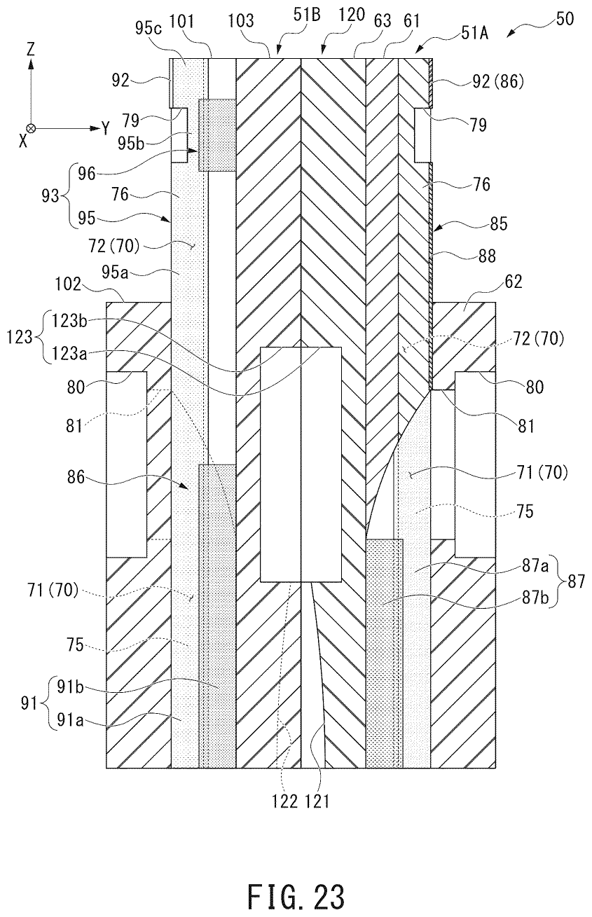

Then, a method of manufacturing the head chip 50 described above will be described. FIG. 11 is a flowchart illustrating the method of manufacturing the head chip 50. FIG. 12 through FIG. 25 are each a process diagram for explaining the method of manufacturing the head chip 50. In this case, out of FIG. 12 through FIG. 21, FIG. 12 through FIG. 14, and FIG. 17 through FIG. 19 are cross-sectional views corresponding to FIG. 10, FIG. 15, FIG. 16, and FIG. 20 are cross-sectional views corresponding to FIG. 7, and FIG. 21 is a cross-sectional view corresponding to FIG. 6. Out of FIG. 12 through FIG. 21, FIG. 23 through FIG. 25 are cross-sectional views corresponding to FIG. 4. In the following description, there is described when manufacturing the head chip 50 chip by chip as an example for the sake of convenience.

As shown in FIG. 11, the method of manufacturing the head chip 50 is provided with a module forming step S1, a module stacking step S2, a return plate stacking step S3, a return plate processing step S4, a protective film forming step S5, and a nozzle plate stacking step S6.

In the module forming step S1, each of the first chip module 51A and the second chip module 51B is formed. The module forming step S1 is provided with an obverse pattern forming step S11, a channel forming step S12, a first wiring forming step S13, a dividing groove forming step S14, a cover plate stacking step S15, a grinding step S16, a second wiring forming step (a drive wiring forming step) S17, a back plate stacking step S18, and a back plate processing step S19. The chip modules 51A, 51B are respectively formed using substantially the same methods. Therefore, in the following description, the module forming step S1 is explained citing the first chip module 51A as an example.

As shown in FIG. 12, in the obverse pattern forming step S11, a mask pattern 200 is formed on the obverse surface of the first actuator plate 61. Specifically, a mask material (e.g., a resist film) is formed on the obverse surface of the first actuator plate 61, and then patterning the mask material is performed using a photolithography technology. The mask pattern 200 is provided with mask openings formed in, for example, portions corresponding to the formation regions of the common terminals 88 and the individual terminals 92 on the obverse surface of the first actuator plate 61.

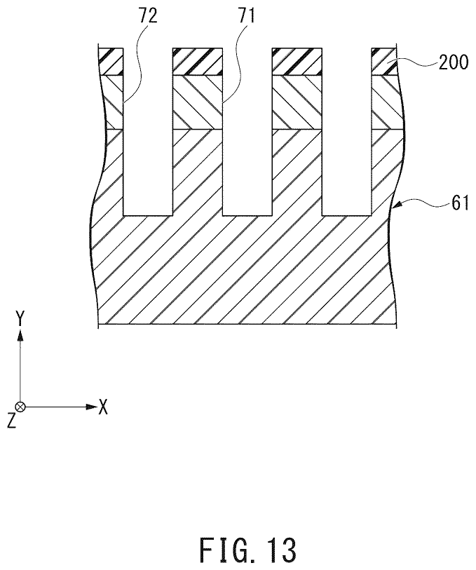

As shown in FIG. 13, in the channel forming step S12, formation areas of the ejection channels 71 and the non-ejection channels 72 in the first actuator plate 61 are processed with a dicer. It should be noted that an amount of entry toward the Y direction of the dicer is set to the extent that both the ejection channels 71 and the non-ejection channels 72 do not penetrate the first actuator plate 61 after the channel forming step S12.

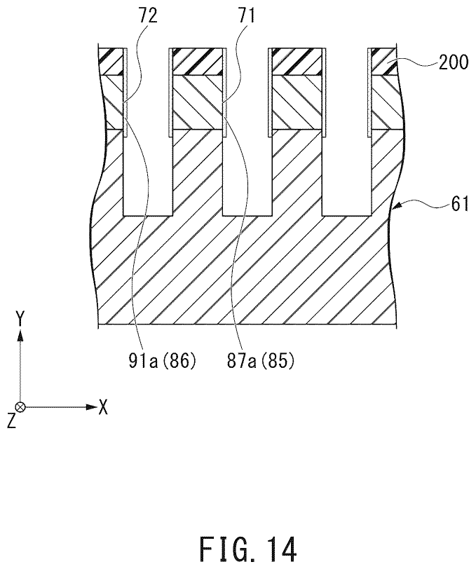

As shown in FIG. 14, in the first wiring forming step S13, an oblique evaporation or the like is performed from an obverse surface side of the first actuator plate 61. Specifically, an electrode material is deposited on the obverse surface of the first actuator plate 61 via the mask pattern 200. Thus, the common terminals 88 and the individual terminals 92 are formed on the obverse surface of the first actuator plate 61.

In the first wiring forming step S13, the electrode material is introduced into the channels 71, 72 via the obverse surface-side opening parts of the respective channels 71, 72. Thus, a part (the obverse surface-side common part 87a) of the common electrode 87 is formed throughout a predetermined range in the Y direction from the obverse surface-side opening edge of the ejection channel 71 on the inner surface of the ejection channel 71. Meanwhile, a part (the obverse surface-side individual part 91a) of the individual electrode 91 is formed throughout a predetermined range in the Y direction from the obverse surface-side opening edge of the non-ejection channel 72 in a portion of the inner surface of the non-ejection channel 72, the portion facing the ejection channel 71 in the X direction. As shown in FIG. 15, a part (the first wiring part 95) of the routing wiring line 93 is formed in a portion of the inner surface of the non-ejection channel 72, the portion being located at a position at the +Z side from the individual electrode 91.

As shown in FIG. 16, in the dividing groove forming step S14, the dividing grooves 79 are each provided to a portion of the tail part 76, the portion being located between the common terminal 88 and the individual terminal 92. Specifically, the dicer is made to run in the X direction in a portion of the obverse surface of the first actuator plate 61, the portion being located between the common terminal 88 and the individual terminal 92. Thus, the portion of the routing wiring line 93, the portion being located on the running trajectory of the dicer, is removed due to the processing of the dividing groove 79. In other words, the second region 95b narrower in width than the first region 95a and the third region 95c remains in a portion on the inner side surface of the non-ejection channel 72, the portion being located at the −Y side with respect to the dividing groove 79. It should be noted that after the dividing groove forming step S14, the mask pattern 200 is removed.

As shown in FIG. 17, in the cover plate stacking step S15, the first cover plate 62 is attached to the obverse surface of the first actuator plate 61.

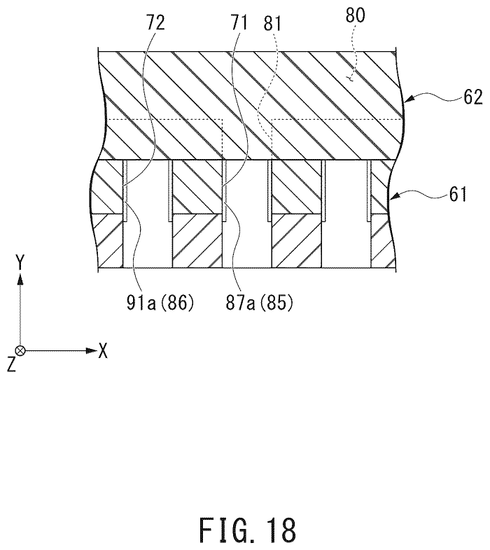

As shown in FIG. 18, in the grinding step S16, grinding processing is performed on the reverse surface of the first actuator plate 61. Specifically, the first actuator plate 61 is ground until the ejection channels 71 and the non-ejection channels 72 open on the reverse surface of the first actuator plate 61.

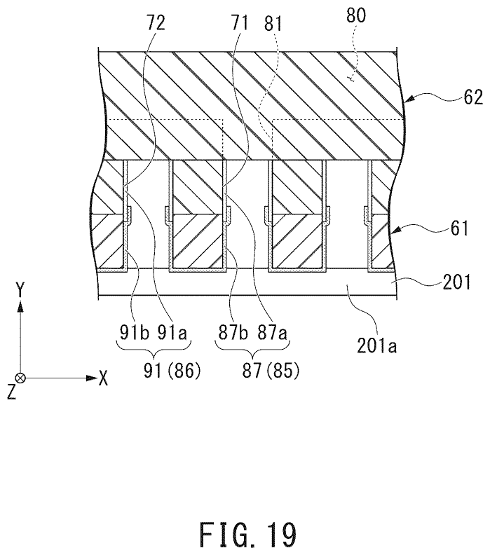

As shown in FIG. 19, in the second wiring forming step S17, the oblique evaporation and so on are performed from the reverse surface side of the first actuator plate 61 in a state in which a mask member 201 is set on the reverse surface of the first actuator plate 61. The mask member 201 has mask openings 201a in portions of the reverse surface of the first actuator plate 61, the portions being provided with the channel array 70 when viewed from the Y direction. The electrode material is introduced to the portions in the channels 71, 72, the portions opening through the mask openings 201a through the reverse surface-side opening parts of the channels 71, 72. Thus, the common electrode 87 (the reverse surface-side common part 87b) is formed throughout a predetermined range in the Y direction from the reverse surface-side opening edge of the ejection channel 71 on the inner surface of the ejection channel 71. As a result, the common electrode 87 is formed throughout the entire area in the Y direction on the inner side surface of the ejection channel 71.

In the second wiring forming step S17, the individual electrode 91 (the reverse surface-side individual part 91b) is formed throughout a predetermined range in the Y direction from the reverse surface-side opening edge of the non-ejection channel 72 on the inner surface of the non-ejection channel 72. As a result, the individual electrode 91 is formed throughout the entire area in the Y direction on the inner side surface of the non-ejection channel 72.

Further, as shown in FIG. 20, a part (the second wiring part 96) of the routing wiring line 93 is formed in a portion of the inner surface of the non-ejection channel 72, the portion being located at a position at the +Z side from the individual electrode 91. Specifically, the electrode material is introduced into the non-ejection channel 72 through a portion of the non-ejection channel 72, the portion being opened through the mask opening 201a when viewed from the Y direction. Thus, the second wiring part 96 is formed so as to be connected to the second region 95b on the inner side surface of the non-ejection channel 72. Further, the electrode material also adheres to a portion of the reverse surface of the actuator plate 61, the portion being exposed through the mask opening 201a. Thus, the bypass wiring line 94 is formed in a portion of the reverse surface of the actuator plate 61, the portion facing the dividing groove 79. It should be noted that the unnecessary electrode material which adheres to a portion of the reverse surface of the actuator plate 61, the portion being exposed through the mask opening 201a, is removed by the laser processing or the like.

As shown in FIG. 21, the electrode material is not introduced into a portion of the non-ejection channel 72, the portion being covered with the mask member 201. Thus, the second wiring part 96 is formed only in a portion of the routing wiring line 93, the portion including the second region 95b. It should be noted that the dividing groove forming step S14 described above may be performed after the second wiring forming step S17.

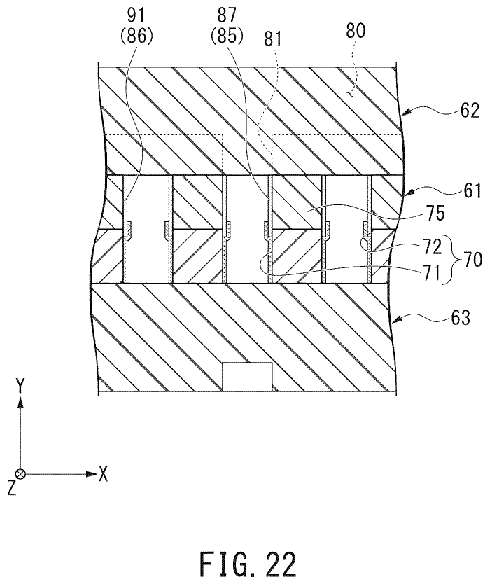

As shown in FIG. 22, in the back plate stacking step S18, the first back plate 63 is attached to the reverse surface of the first actuator plate 61.

In the back plate processing step S19, the first connecting channels 121 and the first recess 123a are provided to the first back plate 63. Thus, the first chip module 51A is completed. It should be noted that by performing substantially the same method as the module forming step S1 described above on the second actuator plate 101 and so on, the second chip module 51B is formed.

As shown in FIG. 23, in the module stacking step S2, the chip modules 51A, 51B formed in the module forming step S1 are bonded to each other. Specifically, the reverse surfaces of the back plates 63, 103 are bonded to each other in a state in which the lower end surfaces of the respective chip modules 51A, 51B coincide with each other. Thus, the reverse side openings of the first connecting channels 121 are closed by the second back plate 103, the reverse side openings of the second connecting channels 122 are closed by the first back plate 63, and at the same time, the manifold 123 is formed with the first recess 123a and the second recess 123b. Thus, the stacked body of the chip modules 51A, 51B is formed.

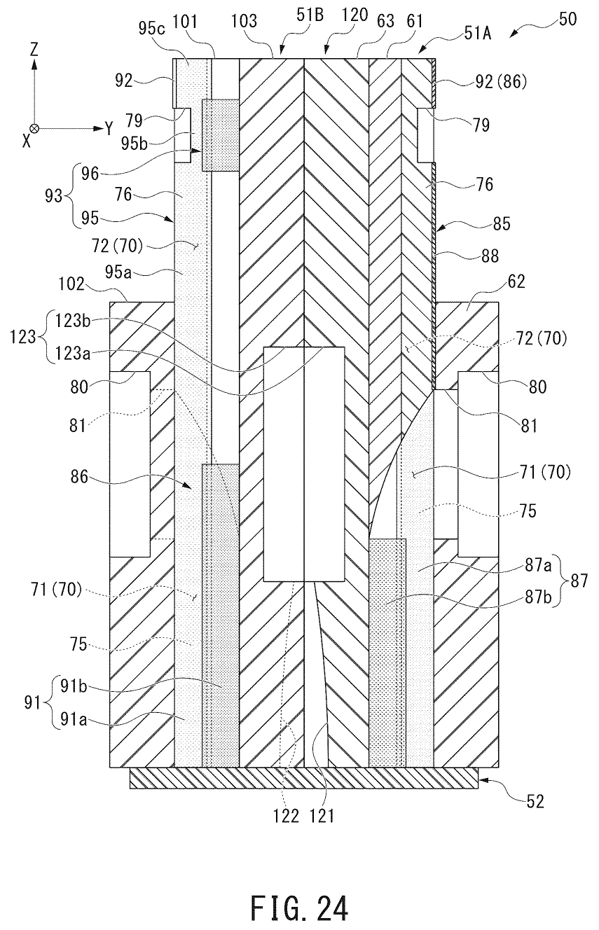

As shown in FIG. 24, in the return plate stacking step S3, the return plate 52 is bonded to a lower end surface in the stacked body of the chip modules 51A, 51B.

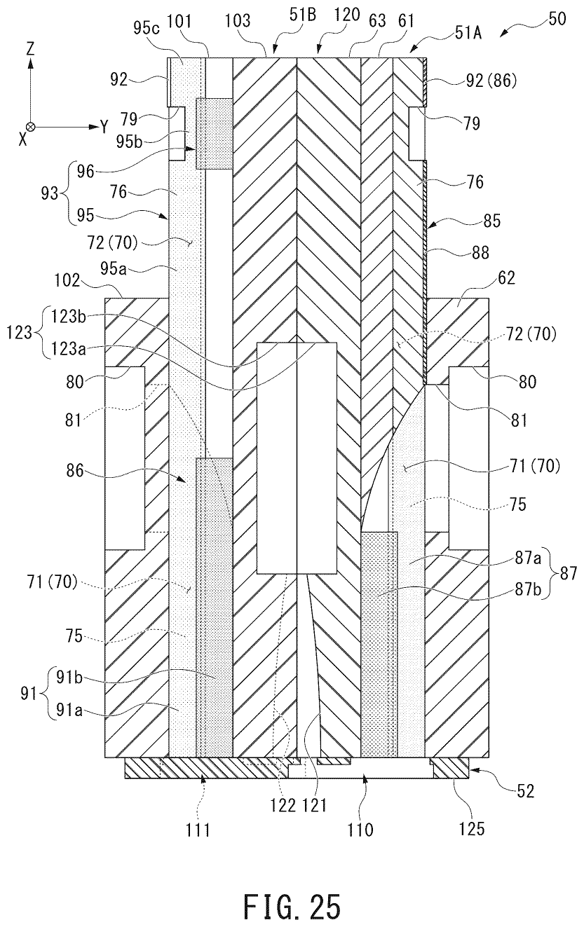

As shown in FIG. 25, in the return plate processing step S4, the communication channels 110, 111 are provided to portions of the return plate 52 overlapping the ejection channels 71 in the plan view. The communication channels 110, 111 are formed by performing, for example, laser processing on the return plate 52. It should be noted that the return plate processing step S4 can be performed using etching or the like besides the laser processing. Further, in the present embodiment, the return plate 52 is bonded to the chip modules 51A, 51B, and then the communication channels 110, 111 are formed, but this configuration is not a limitation. It is possible to provide the communication channels 110, 111 to the return plate 52 in advance using the laser processing, the etching, or the like, and then bond the return plate 52 to the chip modules 51A, 51B.

In the protective film forming step S5, the protective films 125 are formed on the inner surface of the common ink chamber 80, the inner surfaces of the slits 81, the inner surfaces of the ejection channels 71, the inner surfaces of the communication channels 110, 111, the inner surfaces of the connecting channels 121, 122, and the inner surface of the manifold 123. The protective films 125 are formed by depositing a para-xylylene resin material using, for example, a chemical vapor deposition method (CVD).

In the nozzle plate stacking step S6, the nozzle plate 53 is bonded to the lower surface of the return plate 52.

Due to the steps described hereinabove, the head chip 50 is completed. It should be noted that when manufacturing the head chips 50 wafer by wafer, substantially the same step as the module forming step S1 described above is performed on an actuator plate wafer, a cover plate wafer, and a back plate wafer to thereby form a stacked body of the wafers. Subsequently, by segmentalizing the stacked body of the wafers, the plurality of chip modules 51A, 51B is taken out. Subsequently, by performing the module stacking step S2 and subsequent steps on the chip modules 51A, 51B thus taken out from the stacked body of the wafers, the head chips 50 are completed.

As described above, the head chip 50 according to the first embodiment is provided with the actuator plates (chip main bodies) 61, 101 having the ejection channels (the pressure chambers, the jet channels) 71 in which the ink is retained, and the drive walls (drive units) 75 disposed in the portions facing the ejection channels 71, the individual electrodes (drive electrodes) 91 formed on the drive walls 75, and the routing wiring lines (drive wiring lines) 93 which couple the individual electrodes 91 and the flexible printed board (external wiring lines) to each other. The routing wiring lines 93 each have a configuration provided with the first wiring part 95 including the first region 95a and the second region 95b smaller in cross-sectional area perpendicular to the extending direction (the Z direction) of the routing wiring line 93 than the first region 95a, and the second wiring part 96 connected at least to the second region 95b.

According to this configuration, regarding the routing wiring lines 93, by forming the second wiring part 96 so as to be connected at least to the second region 95b of the first wiring part 95, the second region 95b being smaller in cross-sectional area than the first region 95a, it is possible to reduce the maximum resistance value with respect to the whole of the routing wiring line 93. Thus, it is possible to prevent the disconnection and so on of the routing wiring lines 93 even when an unforeseen high current flows through the routing wiring lines 93. As a result, it is possible to provide the head chip 50 excellent in long-term reliability.

In the head chip 50 according to the first embodiment, there is adopted the configuration in which the second wiring part 96 is disposed only in a portion of the routing wiring line 93, the portion including the second region 95b.

According to this configuration, since the second wiring part 96 is disposed only in the portion of the routing wiring line 93, the portion including the second region 95b, it is possible to suppress an increase in material cost of the routing wiring lines 93 due to an addition of the second wiring part 96 compared to when forming the second wiring part 96 so as to cover the whole of the first wiring part 95.

In the head chip 50 according to the first embodiment, there is adopted the configuration in which the second wiring part 96 is disposed so as to be connected integrally to at least the second region 95b in the Y direction (a second direction) along the inner side surface (a surface on which the drive wiring line is deposited) of the non-ejection channel 72 in the plan view.

According to this configuration, since the second wiring part 96 is connected to the second region 95b in the direction along the inner side surface of the non-ejection channel 72, the risk of disconnection and so on can further be reduced. In particular, by ensuring the width dimension of the routing wiring lines 93 as in the head chip 50 according to the first embodiment, the risk of the deposition failure and so on due to adhesion of foreign matters can be reduced compared to when the thickness of the routing wiring line 93 is ensured while keeping the same cross-sectional area.

In the head chip 50 according to the first embodiment, there is adopted the configuration in which the actuator plates 61, 101 are provided with the ejection channels (the pressure chambers, the jet channels) 71 and the non-ejection channels (non-jet channels) 72, the drive electrodes are provided with the common electrodes 87 each formed throughout the entire area in the Y direction on the inner side surfaces of the ejection channel 71 and the individual electrodes 91 each formed throughout the entire area in the Y direction on the inner side surfaces of the non-ejection channel 72, and the routing wiring lines 93 are each coupled to the individual electrode 91 on the inner side surfaces of the non-ejection channel 72.

According to this configuration, in the actuator plates 61, 101 formed of the two piezoelectric substrates different in polarization direction from each other, it is necessary to form the individual electrode 91 throughout the entire area in the Y direction on the inner side surfaces of the non-ejection channel 72. Therefore, by forming the routing wiring lines 93 on the inner side surfaces of the non-ejection channel 72, it is possible to enlarge the routing wiring line 93 in the Y direction with the second wiring part 96 when forming the individual electrodes 91 (the reverse surface-side individual parts 91b). Thus, it is possible to prevent the deterioration of the manufacturing efficiency due to the formation of the second wiring parts 96 since it is unnecessary to separately provide a wiring forming step for forming the second wiring parts 96.

In the head chip 50 according to the first embodiment, there is adopted the configuration in which the dividing grooves 79 for separating the common terminals 88 and the individual terminals 92 from each other are formed on the obverse surfaces of the actuator plates 61, 101, and the second regions 95b are each located in a portion of the inner side surface of the non-ejection channel 72, the portion overlapping the dividing groove 79 in the Z direction.

According to this configuration, since it results in that the second wiring part 96 is formed with respect to the portion overlapping the dividing groove 79 in the Z direction, it is possible to reduce the maximum resistance value with respect to the whole of the routing wiring line 93 while preventing the short circuit between the common terminal 88 and the individual terminal 92.

Since the inkjet head 5 and the printer 1 according to the first embodiment are each equipped with the head chip 50 described above, it is possible to provide the inkjet head 5 and the printer 1 which are excellent in reliability.

### Second Embodiment

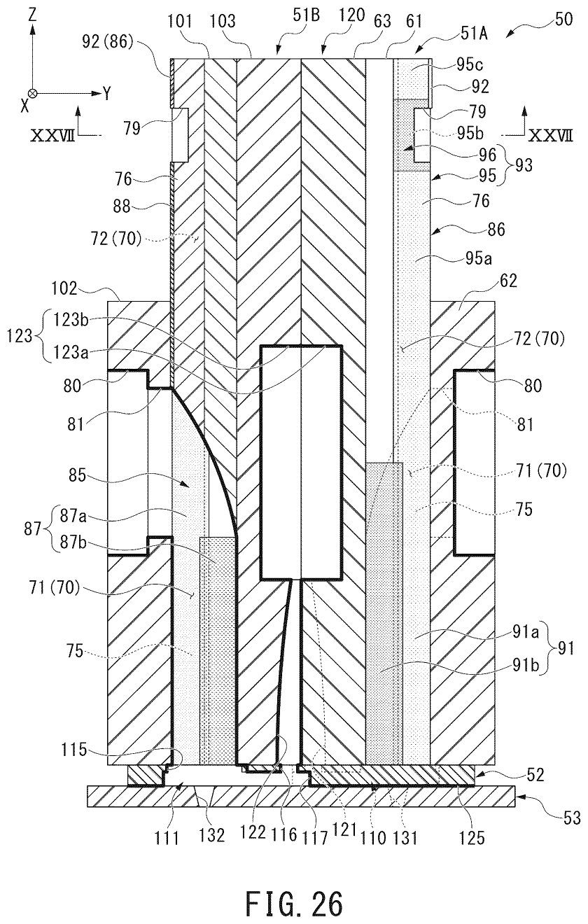

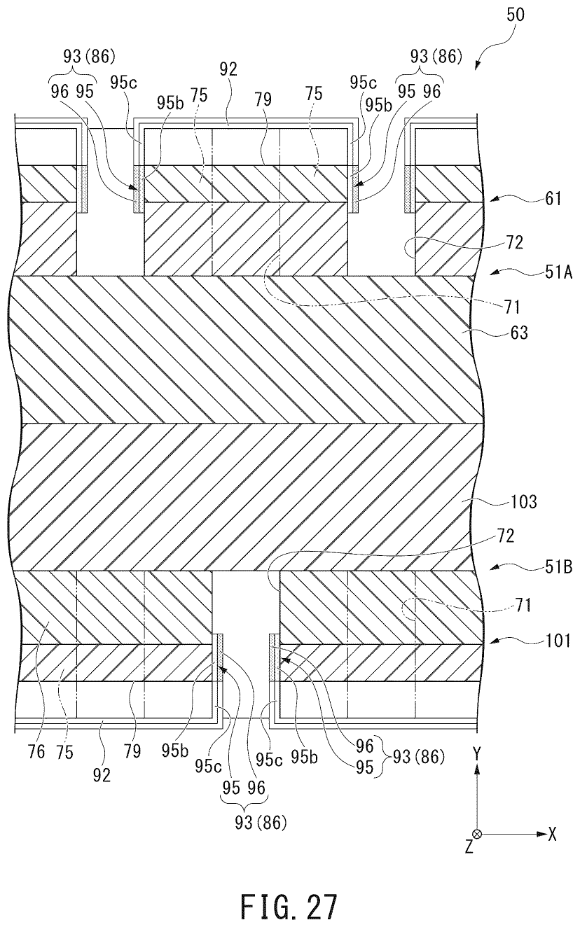

FIG. 26 is a cross-sectional view corresponding to FIG. 5 with respect to the head chip 50 according to a second embodiment. FIG. 27 is a cross-sectional view of a portion corresponding to FIG. 7 with respect to the head chip 50 according to the second embodiment.

As shown in FIG. 26 and FIG. 27, similarly to the first embodiment, in the Z direction, the second wiring part 96 is formed so as to include the whole of the second region 95b and to straddle a boundary portion of the first region 95a with the second region 95b, and a boundary portion of the third region 95c with the second region 95b. On the other hand, in the Y direction, the whole of the second wiring part 96 is disposed so as to overlap the first wiring part 95. Therefore, a region which is a part of the routing wiring line 93, and in which the first wiring part 95 and the second wiring part 96 overlap each other is increased in thickness with respect to a region in which only the first wiring part 95 is formed. In this case, the cross-sectional area in a direction perpendicular to the Z direction in the routing wiring line 93 is set to be larger than the cross-sectional area of the second region 95b alone in any places in the Z direction. In other words, the electric resistance of the routing wiring line 93 is made lower than the electric resistance of the second region 95b alone in any places in the Z direction.

The second wiring parts 96 can be formed by setting the mask member in which only the formation regions of the second wiring parts 96 open to each of the obverse surfaces of the actuator plates 61, 101, and then performing the oblique evaporation once again from the obverse surface side of the actuator plates 61, 101 after, for example, the first wiring forming step S13.

In the head chip 50 according to the second embodiment, there is adopted the configuration in which the second wiring part 96 is disposed so as to cover at least the second region 95b in the X direction perpendicular to the inner side surface (a surface on which the deposition is performed) of the non-ejection channel 72 in the plan view.

According to this configuration, since the second wiring part 96 is disposed so as to cover the second region 95b, it is possible to suppress the growth in size of the routing wiring line 93 in the Y direction (the direction along the surface on which the deposition is performed) due to the addition of the second wiring part 96. Thus, it is possible to reduce the maximum resistance value of the whole of the routing wiring line 93 while suppressing an increase in capacitance.

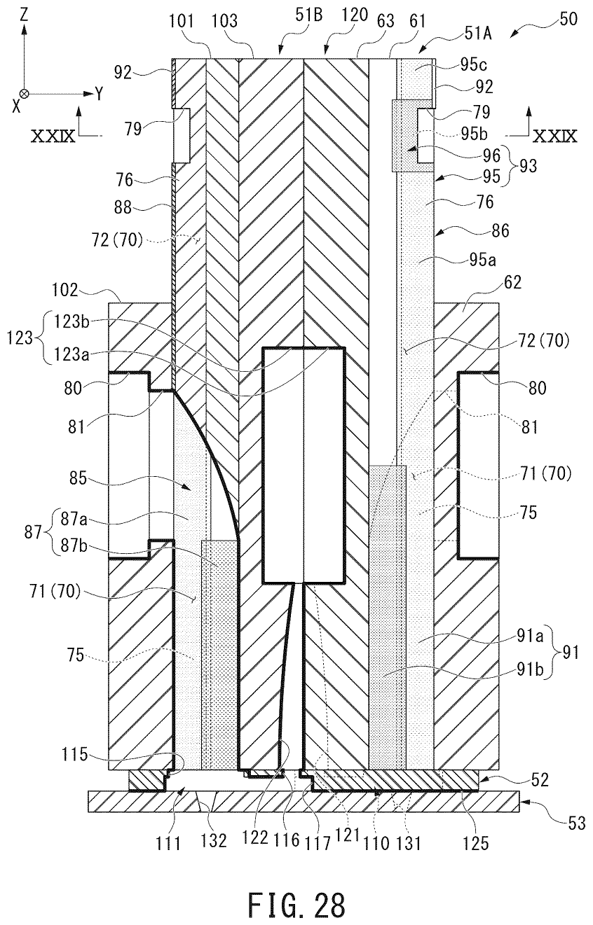

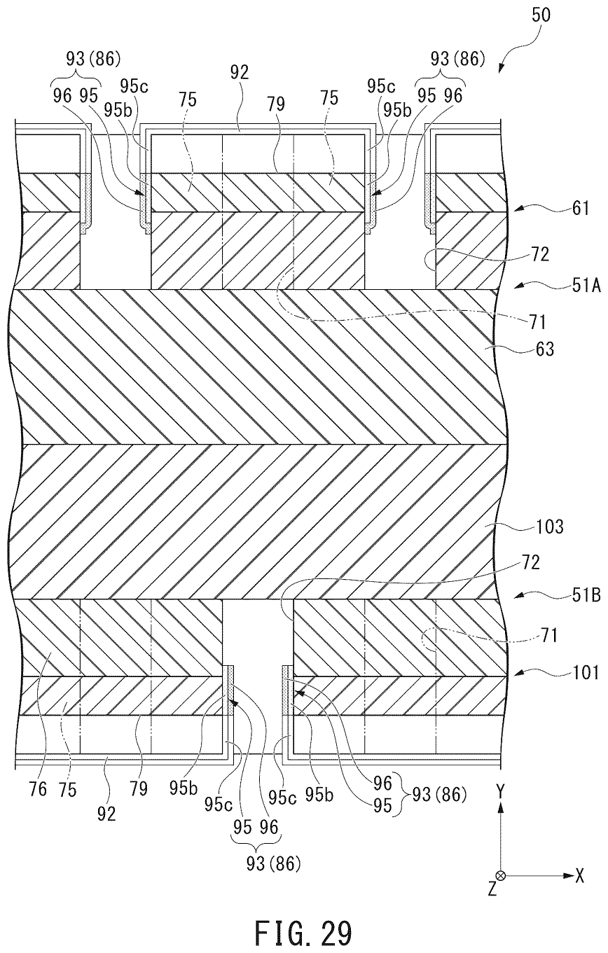

It should be noted that it is possible to overlap a part of the second wiring part 96 with the whole of the first wiring part 95 in the Y direction, and then form the rest of the second wiring part 96 so as to protrude toward the −Y side from the first wiring part 95 as in the second wiring part 96 shown in FIG. 28 and FIG. 29.

### Other Modified Examples

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording apparatus, but the liquid jet recording apparatus is not limited to the printer. For example, a facsimile machine, an on-demand printing machine, and so on can also be adopted.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiments described above, there is explained when the recording target medium P is paper, but this configuration is not a limitation. The recording target medium P is not limited to paper, but can also be a metal material or a resin material, and can also be food or the like.

In the embodiments described above, there is explained the configuration in which the liquid jet heads are installed in the liquid jet recording apparatus, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, there is explained the configuration in which the Z direction coincides with the gravitational direction, but this configuration is not a limitation, and it is also possible to set the Z direction to a direction along the horizontal direction.

In the embodiments described above, there is explained the configuration (so-called pulling-shoot) of deforming the actuator plate in the direction of increasing the volume of the ejection channel due to the application of the drive voltage, and then restoring the actuator plate to thereby eject the ink, but this configuration is not a limitation. It is possible for the head chip according to the present disclosure to be provided with a configuration (so-called pushing-shoot) in which the ink is ejected by deforming the actuator plate in a direction of reducing the volume of the ejection channel due to the application of the voltage. When performing the pushing-shoot, the actuator plate deforms so as to bulge toward the inside of the ejection channel due to the application of the drive voltage. Thus, the volume in the ejection channel decreases to increase the pressure in the ejection channel, and thus, the ink located in the ejection channel is ejected outside through the nozzle hole. When setting the drive voltage to zero, the actuator plate is restored. As a result, the volume in the ejection channel is restored.

In the embodiment described above, there is explained the configuration in which the chip modules 51A, 51B are overlapped with each other, but this configuration is not a limitation. It is possible to configure the head chip 50 only with the first chip module 51A.

In the embodiments described above, the description is presented citing the head chip of the edge-shoot type as an example, but this configuration is not a limitation. For example, it is also possible to apply the present disclosure to the head chip 50 of a so-called side-shoot type for ejecting the ink from a central portion in the extending direction in the ejection channel 71. Further, the head chip may be of a so-called roof-shoot type in which a direction of the pressure applied to the ink and the ejection direction of the ink are made the same as each other. In the case of the roof-shoot type, a portion which faces the pressure chamber retaining the ink, and which deforms for expanding or contracting the pressure chamber, functions as a drive unit.

In the embodiments described above, there is explained the configuration in which the second wiring part 96 overlaps the second region 95b when viewed from the thickness direction (the X direction), but this configuration is not a limitation. It is sufficient for the second region 95b and the second wiring part 96 to be at least electrically coupled to each other. In this case, a configuration in which, for example, the reverse surface-side end edge of the second region 95b and the obverse surface-side end edge of the second wiring part 96 are connected only in the Y direction in the state in which these do not overlap each other when viewed from the X direction may be adopted.

In the embodiments described above, there is explained the configuration in which the second wiring part 96 is formed in a region of the first wiring part 95, the region including the second region 95b, but this configuration is not a limitation. The second wiring part 96 may overlap throughout the entire length in the Z direction in the first wiring part 95.

In the embodiments described above, there is explained when defining a portion of the routing wiring line 93, the portion being provided with the dividing groove 79, as the second region 95b, and additionally providing the second wiring part 96 to the second region 95b, but this configuration is not a limitation. For example, it is possible to additionally form the second wiring part in portions (the second regions) of the drive wiring lines such as the common terminal 88 and the individual terminal 92 configured to couple the common electrode 87 and the individual electrode 91 to the external wiring lines, the portions being apt to increase in electric resistance.

In the embodiments described above, there is explained the configuration provided with the first wiring forming step S13 and the second wiring forming step S17, but a configuration in which the second wiring forming step S17 is performed on the actuator plates which has already been provided with the first wiring parts 95 may be adopted.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
a chip main body including a pressure chamber configured to retain a liquid and a drive unit disposed in a portion facing the pressure chamber;
a drive electrode provided to the drive unit; and
a drive wiring line which is provided to the chip main body, and is configured to couple the drive electrode and external wiring lines to each other, wherein
the drive wiring line includes
a first wiring part including a first region, and a second region which is coupled the first region in an extending direction of the drive wiring line, and is smaller in cross-sectional area perpendicular to the extending direction than the first region, and
a second wiring part connected to at least the second region in a direction crossing the extending direction.

2. The head chip according to claim 1, wherein
the second wiring part is disposed only in a portion of the drive wiring line, the portion including the second region.

3. The head chip according to claim 1, wherein
the second wiring part is disposed so as to cover at least the second region in a first direction perpendicular to a surface on which the drive wiring line is deposited in the chip main body when viewed from the extending direction.

4. The head chip according to claim 1, wherein
the second wiring part is disposed so as to be integrally connected to at least the second region in a second direction along a surface on which the drive wiring line is deposited in the chip main body when viewed from the extending direction.

5. The head chip according to claim 4, wherein
the chip main body is provided with an actuator plate configured by stacking, in the second direction, two piezoelectric substrates different in polarization direction from each other in the second direction,
the actuator plate is provided with
a jet channel as the pressure chamber configured to retain the liquid, and
a non-jet channel which is adjacent to the jet channel, and is configured not to retain the liquid,
the drive unit is configured with a portion of the actuator plate, the portion being located between the jet channel and the non-jet channel,
the drive electrode includes
a common electrode formed at a portion of the drive unit, the portion facing the jet channel, throughout an entire area of the portion in the second direction, and
an individual electrode formed at a portion of the drive unit, the portion facing the non-jet channel, throughout an entire area of the portion in the second direction, and
the drive wiring line is coupled to the individual electrode in the portion of the drive unit, the portion facing the non-jet channel.

6. The head chip according to claim 5, wherein
an obverse surface of the actuator plate is provided with a dividing groove configured to separate a common terminal configured to couple the common electrode and the external wiring line to each other, from an individual terminal configured to couple the individual electrode and the external wiring line to each other, and
the second region is located in a portion of the drive unit, the portion facing the non-jet channel and overlapping the dividing groove in the extending direction.

7. A liquid jet head comprising:
the head chip according to claim 1.

8. A liquid jet recording apparatus comprising:
the liquid jet head according to claim 7.

9. A method of manufacturing a head chip comprising:
a drive wiring forming step of providing a chip main body including a pressure chamber configured to retain a liquid, and a drive unit which is disposed in a portion facing the pressure chamber, and is provided with a drive electrode, with a drive wiring line configured to couple the drive electrode and an external wiring line to each other, wherein
in the drive wiring forming step, the chip main body provided with a first wiring part including a first region, and a second region which is coupled to the first region in an extending direction of the drive wiring line, and is smaller in cross-sectional area perpendicular to the extending direction than the first region is provided with a second wiring part formed so as to be connected to at least the second region in a direction crossing the extending direction.
